(19) United States
(12) Patent Application Publication
(10) Pub. No.: US 2006/0184585 A1
(43) Pub. Date: Aug. 17, 2006

(54) Communication point delivery instructions

(75) Inventors: Michael B. Grear, Omaha, NE (US); Gretchen L. Donlin, Gretna, NE (US); Margaret Ann Henry-Saal, Omaha, NE (US); Patricia L. Melanson, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/371,165

(22) Filed: Mar. 7, 2006

Related U.S. Application Data
(63) Continuation-in-part of application No. 10/971,831, filed on Oct. 22, 2004.
(63) Continuation-in-part of application No. 10/972,093, filed on Oct. 22, 2004.
(63) Continuation-in-part of application No. 10/972,172, filed on Oct. 22, 2004.
(60) Provisional application No. 60/567,891, filed on May 3, 2004.
(60) Provisional application No. 60/547,651, filed on Feb. 24, 2004.
(60) Provisional application No. 60/567,891, filed on May 3, 2004.
(60) Provisional application No. 60/547,651, filed on Feb. 24, 2004.
(60) Provisional application No. 60/567,891, filed on May 3, 2004.
(60) Provisional application No. 60/547,651, filed on Feb. 24, 2004.

(51) Int. Cl. G06F 17/30

(52) U.S. Cl. 707/200

(57) ABSTRACT

According to various embodiments of the invention, an architecture is provided for a data processing system. The elements of the architecture can be managed separately. For example, the architecture can be organized around eight subject areas, such as account, party, communication point, presentation instrument, rules, balances, transactions, and product. Relationships between each of the subject areas as well as between sub-types of each subject area can be established to provide flexibility in the management of the data.

### CROSS-REFERENCES TO RELATED APPLICATIONS

This application is a continuation-in-part of U.S. patent application Ser. No. 10/972,172, filed on Oct. 22, 2004, entitled “System For Maintaining Communication Point Data,” a continuation-in-part of U.S. patent application Ser. No. 10/971,831, filed on Oct. 22, 2004, entitled “System For Maintaining Party And Communication Point Data,” and a continuation-in-part of U.S. patent application Ser. No. 10/972,093, filed on Oct. 22, 2004, entitled “System For Maintaining Party Data.” This application also claims the benefit under 35 USC § 119(e) of U.S. Patent Application No. 60/547,651, filed on Feb. 24, 2004, entitled “System And Method For Transaction Processing,” as well as the benefit under 35 USC § 119(e) of U.S. Patent Application No. 60/567,891, filed May 3, 2004, entitled “System And Method For Transaction Processing.”

This application is related to the following U.S. patent applications: U.S. patent application Ser. No. ______, filed on a date even herewith by Grear et al., Attorney Docket Number 020375-048850US, entitled “Communication Point Bulk Mail,” and U.S. patent application Ser. No. ______, filed on a date even herewith by Grear et al., Attorney Docket Number 020375-048870US, entitled “Communication Point Relationship Scheduling.” This application hereby incorporates by reference herein the content of each of the aforementioned applications in their entirety and for all purposes.

### FIELD OF THE INVENTION

Embodiments of the invention relate generally to systems managing certain types of Databases, and more particularly the structure and configuration of such Databases.

### BACKGROUND

Credit card transaction management and administration is an example of a processing system that has traditionally relied on storing a great deal of information with a single identifier used as a reference. For example, a credit card account typically includes information about the customer, the account, the billing address, the formal transaction information, and the credit card and physical credit card characteristics. All of this is handled from the perspective of a single account, so that the credit card company can track transactions for a particular customer. Thus, this results in a very static data processing system that is inflexible which makes it difficult to effect changes as the business it services evolves. Furthermore, the handling of this information is typically specific to a particular line of business within an industry such as a revolving credit product for the financial services industry. It is not readily aligned with a totally different service model, such as one's utility billing system, insurance claim payment processing system, phone billing system, or cable billing system.

Thus, a third party which handles the processing of transactions for a variety of different industries or services must create independent systems for handling each service's transactions. There currently appears to be no unique system which is capable of flexibly handling different types of services, such as credit card processing, healthcare claim payment, and utility bill processing, in the same processing system. Again, the static and inflexible nature of the current processing systems prevent this.

In addition, because the account information, party information, communication point information and presentation instrument information for a credit card system, for example, is referenced by a single identifier, it is quite difficult, if not impossible, under present systems, to manage the individual areas of account information, party information, communication point information or presentation instrument as independent data. Once again, the inflexible nature of a single reference to the data prevents this from happening.

As another example of the inflexibility of current systems, it is not easy to modify existing systems to add multiple parties and the requisite roles they play to an account and utilize multiple presentation instruments for access to that account. Again, this is difficult due to the fact that once an account is created under the static formatting of a particular account—such as the formatting of a Mastercard Gold Card with a single customer—it is extremely difficult to modify that record to reflect change—such as a second party, playing a previously unsupported role, on the account—without restructuring the processing system (underlying data structures and program code).

Another example of the inflexibility of credit card systems is that customers are typically prevented from playing dual roles in an account, such as the role of guarantor and authorized user. Instead, the credit card account is typically configured to identify one party as the authorized user and a different party as the guarantor. Once again, this prevents the flexibility that might be desired in certain circumstances.

Yet another example of the rigidity of current systems is that, for products offered by a bank, for example, which offers different credit card lines as well as brokerage accounts and mortgages, each of those individual accounts is typically processed separately, under separate systems. It is not possible to easily combine those systems at a later point in time under a master account which could be tailored to the services desired by a particular customer.

As yet another example, the static nature of current systems makes it difficult, if not impossible, to modify the mailing contact points for an individual during different times of the year. For example, a credit card statement is typically mailed to a home residence of the customer who is financially responsible for the account. Current systems do not provide the flexibility to allow a customer to designate varying locations during the year to which statements should be sent. This is due to the fact that only a single address is currently associated with a credit card account, for example, without the flexibility to designate different contact points throughout the year. To include such information would require a complete reworking of the credit card processing system because the credit card processing system operates by referring to all account information using a single reference identifier.

Thus, as can be seen from the above examples, current processing systems for service industries are typically configured in a static and inflexible way so as to effectively prevent the efficient management of information for an account. Other examples addressed by present embodiments of the invention will be apparent from the following specification.

Thus, there is a need for a data processing system which can handle the processing of data for service industries in a more flexible manner. For example, there is a need for a data processing system and requisite data architecture that can easily adapt to changing business requirements and is not tightly coupled with a specific aspect of any one service or any one industry.

### SUMMARY

According to various embodiments of the invention, a method of storing data for communicating with different parties is provided. Data is stored which identifies one or more communication points, each point stored as a separate set of data. Data is stored which identifies one or more parties, each party stored as a separate set of data. A set of party data is linked with a set of communication point data, and delivery instructions are associated with the link specifying a procedure to use in delivering communications directed to the party at the communication point. One or more accounts may be associated with the link, as well.

The set of party data may be associated with other sets of communication point data, using other links. Similarly, the set of communication point data may be associated with other sets of party data, using other links. Various delivery instructions may be associated with each other link, specifying different procedures to use in delivering communications to the other communication point-party links. Delivery instructions may be associated with a link for a specified, or recurring, period of time. Different identifiers may also be used to identify and link the sets of party, communication point, and account data. The identifiers may also be stored independently.

In another embodiment of the invention, data is stored which identifies one or more accounts, each account stored as a separate set of data. A set of account data is linked with a set of communication point data, and delivery instructions are associated with the link specifying a procedure to use in delivering communications for the account at the communication point. One or more parties may be associated with the link, as well. Different identifiers may also be used to identify and link the sets of party, communication point, and account data. The identifiers may also be stored independently.

Other embodiments include a system of storing data for communicating with a party over different time periods. The system includes a communication point database for storing data identifying a number of communication points, each communication point stored separately. A party database stores a set of data identifying a party, and a communication point usage database comprises a link between the set of party data and a first communication point. The link also includes delivery instructions specifying the procedure to use in delivering communications to the communication point for the party. In some embodiments, an account database stores data identifying a number of accounts, and the account database is stored separately from the party database and the communication point database. The link is further associated with an account from the account database. Again, different identifiers may also be used to identify and link the sets of party, communication point, and account data. The identifiers may also be stored independently.

### BRIEF DESCRIPTION OF THE DRAWINGS

FIG. 1A is a block diagram illustrating the architecture of a data processing system for managing service industry data according to one embodiment of the invention.

FIG. 1B illustrates a data processing system for implementing the architecture shown in FIG. 1A.

FIG. 1C illustrates a block diagram of a computing system for implementing any of the computer processing systems in the embodiments of the invention described herein.

FIGS. 2A and 2B illustrate a flowchart for implementing a method of processing data for a service business according to one embodiment of the invention.

FIGS. 3A and 3B illustrate a flowchart for implementing a method of processing data according to one embodiment of the invention.

FIG. 4A illustrates a block diagram of an exemplary way of relating entries in different databases for facilitating one embodiment of the invention.

FIG. 4B illustrates a flowchart for processing data in a party-account relationship, according to one embodiment of the invention.

FIGS. 5A and 5B illustrate a flowchart demonstrating a method of processing data in a party-account relationship, according to one embodiment of the invention.

FIG. 6 illustrates a flowchart for implementing a method of processing data for a party-communication point relationship according to one embodiment of the invention.

FIG. 7 illustrates a flowchart for implementing a method of processing data for a party-communication point relationship according to one embodiment of the invention.

FIG. 8 illustrates a block diagram setting forth an exemplary way of relating entries in a party communication point database.

FIG. 9 illustrates a block diagram setting forth an exemplary way of relating a party and communication point.

FIG. 10 illustrates a block diagram setting forth an exemplary way of relating a party and communication point for a specified time period.

FIG. 11 illustrates a flowchart for implementing a method of processing a plurality of party-communication point relationships according to one embodiment of the invention.

FIG. 12 illustrates a flowchart for implementing an alternative method of processing data for a party-communication point relationship according to one embodiment of the invention.

FIG. 13 illustrates a flowchart for implementing a method of using identifiers in processing data for a party-communication point relationship according to one embodiment of the invention.

FIG. 14A illustrates a block diagram of an exemplary configuration for the party subject area, according to one embodiment of the invention.

FIGS. 14B and 14C illustrate a block diagram of another exemplary configuration for the party subject area, according to one embodiment of the invention.

FIGS. 15A, 15B, and 15C illustrate a block diagram of an exemplary configuration for the account subject area, according to one embodiment of the invention.

FIGS. 16A and 16B illustrates a block diagram of an exemplary configuration for the Communication Point subject area, according to one embodiment of the invention.

FIG. 17 illustrates a block diagram of an exemplary configuration for Bulk Mail usage according to one embodiment of the invention.

FIGS. 18-21 illustrate block diagrams of a variety of exemplary configurations for Bulk Mail usage according various embodiments of the invention.

FIG. 22 illustrates a flowchart for implementing a method of processing data for a bulk mailing according to one embodiment of the invention.

FIG. 23 illustrates a flowchart for implementing a method of using identifiers in processing data processing data for a bulk mailing according to one embodiment of the invention.

FIGS. 24-25 illustrate block diagrams of a variety of exemplary configurations for defining delivery instructions according to various embodiments of the invention.

FIG. 26 illustrates a flowchart illustrating a method for defining delivery instructions for certain communications according to one embodiment of the invention.

FIG. 27 illustrates a flowchart illustrating an alternative method for defining delivery instructions for communications according to one embodiment of the invention.

FIG. 28 illustrates a flowchart for implementing a method of using identifiers in processing data for delivery instructions according to one embodiment of the invention.

### DETAILED DESCRIPTION

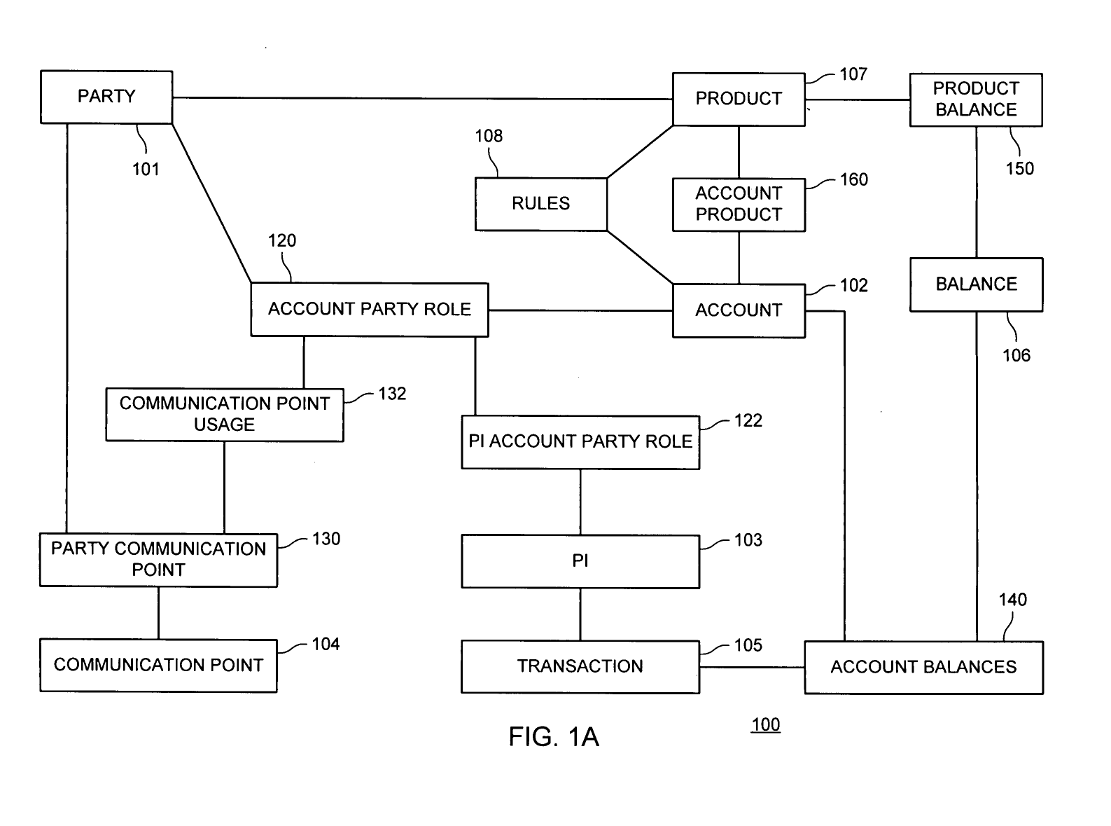

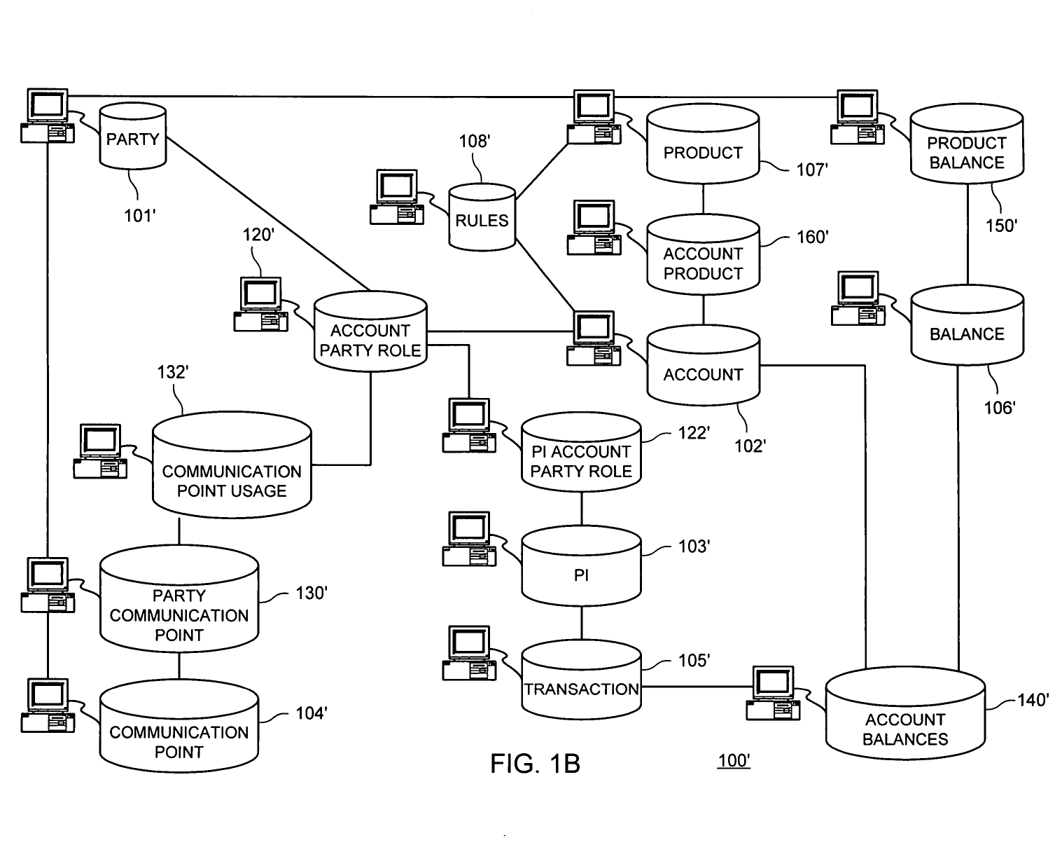

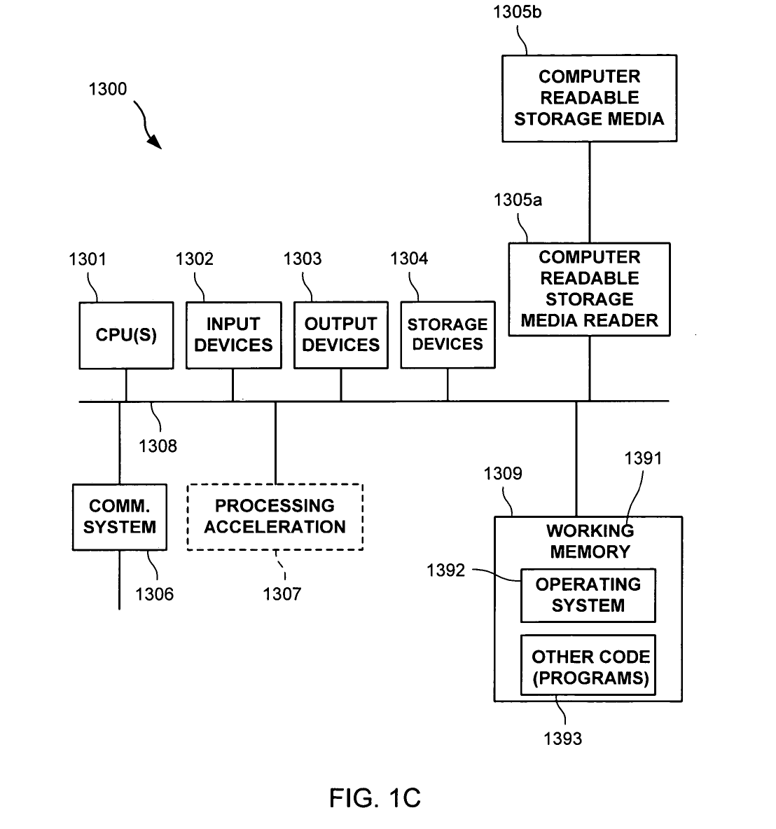

Referring now to FIG. 1A, a data architecture for implementing an embodiment of the invention is shown. Namely, in FIG. 1A, a data architecture is shown that is divided into eight different subject areas, relationships between the subject areas, and the resulting associations between them. For example, FIG. 1A illustrates in system 100 the following subject areas: party 101, account 102, presentation instrument 103, communication point 104, transaction 105, balance 106, product 107 and rules 108. Furthermore, between subject areas, different associations are shown. For example, between party 101 and communication point 104, party-communication point associations 130 is shown. Similarly, between party 101 and account 102, an account-party role association is shown. Furthermore, between presentation instrument 103 and account-party role associations 120, a presentation instrument-account-party role 122 relationship is shown. Similarly, communication point usage 132 is shown positioned between the party-communication point associations 130 and the account-party-role associations 120. FIG. 1A also shows between product 107 and balance 106, the product-balance associations 150. Furthermore, it shows between account 102 and product 107, an account-product associations 160. Finally, between account 102 and balance 106, FIG. 1A shows an account-balance associations 140.

FIG. 1B illustrates a processing system for implementing the data architecture shown in FIG. 1A. Furthermore, each of the subject areas, relationships, and associations shown in FIG. 1A are illustrated by a computer and database in FIG. 1B. A computer and database can be used to store independently the information for each subject area: party 101′, account 102′, presentation instrument 103′, communication point 104′, transaction 105′, balance 106′, product 107′, and rules 108′. In addition, a database and computer can be utilized to store the information for each relationship established between the different subject areas. For example, the database can be used to store internal identifiers from the party database and account database in database 120′ for storing information in regard to an account-party role. Similarly, a database can be utilized to store information for the party-communication point relationship as database 130′. Other databases are shown in FIG. 1B in conformance with FIG. 1A, such as communication point usage database 132′, PI-account-party-role database 122′, account-balance database 140′, account-product database 160′, and product-balance database 150′. Each database is designated in conformance with the architecture shown in FIG. 1A.

Each of the computers and databases shown in FIG. 1B can be implemented by the exemplary computer system illustrated in FIG. 1C. FIG. 1C broadly illustrates how individual system elements can be implemented. System 1300 is shown comprised of hardware elements that are electrically coupled via bus 1308, including a processor 1301, input device 1302, output device 1303, storage device 1304, computer-readable storage media reader 1305a, communications system 1306 processing acceleration (e.g., DSP or special-purpose processors) 1307 and memory 1309. Computer-readable storage media reader 1305a is further coupled to computer-readable storage media 1305b, the combination comprehensively representing remote, local, fixed and/or removable storage devices plus storage media, memory, etc. for temporarily and/or more permanently containing computer-readable information, which can include storage device 1304, memory 1309 and/or any other such accessible system 1300 resource. System 1300 also comprises software elements (shown as being currently located within working memory 1391) including an operating system 1392 and other code 1393, such as programs, applets, data and the like.

System 1300 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 1300 component (e.g. within communications system 1306). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) Not all system 1300 components will necessarily be required in all cases.

The data architecture shown in FIG. 1A provides a great deal of flexibility for managing data or providing data processing for a service industry. Prior data architectures in the credit card industry, for example, relied upon the referencing of all the information for a customer's account through the use of a single identifier. Similarly, in the utility billing system, all the information for a particular user is referenced as a single set of combined data. The architecture illustrated in FIG. 1A does not reference all of the information for a service by a single identifier for a static record. Rather, it separates information into distinct subject areas. Thus, one is capable of providing a great deal of flexibility to data processing. For example, one can modify the data for a particular party without disrupting processing of that party's account. Essentially, no restructuring of other subject areas is required because an individual subject area can be modified without impacting the other subject areas. Therefore, this type of system provides a great deal of flexibility and functionality that existing systems cannot accomplish.

Referring to FIG. 1A, the various subject areas can be seen. Furthermore, the relationships and resulting associations established between many of the different subject areas can be seen as well. These relationships and associations permit the processing of stored data for desired functionality.

Account

Referring to block 102 of FIG. 1A, the account subject area can be seen. The account subject area is a collection of data about the mechanism used to record, measure, and track financial and non-financial information related to a contractual agreement. Accounts can be characterized by specific components, terms or conditions of data of the service or product that prompted the account's creation. An account can further be characterized by financial data. Thus, according to one embodiment of the invention, the account facilitates the management, tracking, and reporting of transaction activities. The specific characteristics of an account may vary based on the type of product, product components, party, or terms and conditions established in the contractual agreement.

An account is associated to one or more parties who can use one or more presentation instruments to generate transactions. Furthermore, according to one embodiment of the invention, an account, a party, and a presentation instrument can operate as independent subject areas and can be related in an association to form a unique occurrence of the relationship.

The account subject area provides for the separation of account data from party data and presentation instrument data. Thus, the identity of a party who fulfills a specific business role for a particular account is not stored as part of the account database. Rather, it is kept in the party database and related to the account database where the assigned business role is maintained. Similarly, the data describing the presentation instrument, such as a credit card or smart card, is not stored as part of the account's data. Rather, this information can be related with the account's data by an association database.

An account can participate in one or more relationships with other accounts, for example, as a member of a business group or family group of accounts. Furthermore, multiple presentation instruments can generate transactions for a single account, a group of accounts, or a single member of a group. Thus, a single account could be related with a smart card, a magnetic stripe card, a biometric identifier, etc., each of which could be utilized to initiate a transaction associated with the account.

For example, an individual account associated with several parties can be related with one presentation instrument to generate transactions. Alternatively, a family account with each family member having individual or subordinate accounts can be implemented with the account subject area. Furthermore, a corporate account with one or more dependent accounts could be implemented through the account database. Thus, it is clear that by segregating data for an account, flexibility is provided under the data architecture shown in FIG. 1A.

Party

Referring to FIG. 1A, the party 101 subject area can be seen. The party subject area is a collection of data about individuals, organizations, or organization units that the service provider needs to have information about in order to carry out business operations either directly or indirectly. Parties can be related to other parties as well as to accounts, presentation instruments, balances, products, communication points, and transactions. They can participate in agreements, groups, and organizations. They can act as owners, stewards, contact points, and catalysts of business functions and rules.

For example, customer John Joseph Doe may be known to one client of the data processor as J. Doe, and to another client of the data processor as J. Joseph Doe, Sr. Each client (e.g., Bank One and XCEL Energy) may add a different address for John Doe even though both have the same social security number for him and both know that his birth date was Jun. 10, 1942. The names used by one client of the data processor are not combined with those used by the other clients of the data processor because each is relevant only within the context of the business that provided the information. The party subject area however can store identifying information for the party, such as name and social security number that can be related to many different accounts.

The account to which a party is associated is not stored as part of the party's database. Similarly, the communication point at which a party can be contacted is also not stored as part of the party's database. Rather, the account and/or communication point are related to the party by associative databases.

The party database can provide flexibility to maintain multiple names, statuses, and alternative identifiers for an individual, organization, or organizational unit. It also allows a service organization to manage multiple roles in relationships for an individual, organization, or organizational unit. It further allows one to build and maintain structural relationships between individuals, organizations, and/or organizational units such as peer-to-peer relationships or hierarchical relationships.

Examples of the relationships between parties are customers of a service provider (credit card companies, utility companies, healthcare providers), clients of a data processing system such as receiving banks, vendors, merchants, contacts, business partners, and employees.

Presentation Instrument

Referring again to FIG. 1A, a block 103 entitled “presentation instrument” is shown. The presentation instrument subject area is a collection of data about physical or virtual devices used as a transaction catalyst to generate transactions, either monetary or non-monetary. The presentation instrument data is stored independently from party and account data in order to facilitate its management. Characteristics of presentation instrument data can be modified without affecting the account or the account status. Presentation instruments are not restricted to being physical devices, such as paper invoices, plastic credit cards, plastic magnetic stripe cards, or smart cards. Rather, they can also be virtual devices, such as a stated account number or an electronic identifier. Any catalyst for initiating a transaction against an account is considered a presentation instrument.

The presentation instrument data can be independently managed. Thus, the presentation instrument data may be related to one or more party/product/account relationships. For example, a party could require reissuance of a “presentation instrument”, such as a credit card, without affecting other credit cards on the same account. Similarly, a virtual presentation instrument could be created for an account to allow the party to enable e-commerce activity without affecting any associated physical presentation instruments.

Communication Point

Another subject area shown in FIG. 1A is communication point 104. The communication point subject area identifies the destination points used for the delivery of communications, e.g., the virtual or physical points where communication(s) can be received. A communication point can be a geographic address; an electronic address, such as an email address; a telecommunication number, such as a telephone or fax number; or any other type of destination point to which a communication can be addressed. Typically, an association will be established between a party and a communication point to describe the relationship of the party to a particular communication point; e.g., one geographic address might be related to a party as the party's home address, another to a party as the party's work address, etc. These associations can be stored in a different database and/or can be used to specify what types of communications can be delivered to them. However, the communication point database stores information about the communication point itself to which relationships are established and various types of communications are sent.

One of the benefits of storing information in a communication point database is that the information can readily be changed when the issuing body changes the content for the communication point. Furthermore, many different communication points can be utilized for a single party by relating the party to those communication points and/or a single communication point can be related to many parties. This provides great flexibility for sending communications to a party depending upon the type of relationship that party has with a communication point and the time at which that relationship is used. Another example of the inherent flexibility is that as business requirements change and new types of communication points are discovered they can be added to the processing system with very little effort.

For example, a communication point could be used to send a specific party the annual statement for a credit card company. The party may only live at its home address for part of the year and live at a different address for another part of the year, as is often the case for retirees. Thus, multiple communication points could be included in a communication point database and an association could be established with the party database to specify the relationship, timing, and usage of the communication point data. These associations can be stored in different databases such as party-communication point database 130 and communication point usage database 132. Thus, the annual statement could be directed to one or more geographic or e-mail addresses during a first part of the year and yet a single geographic address during another part of the year.

One of the benefits of storing information in a communication point database is that the communication point information can change without the relationship to a party changing. Thus, for example, if a district revises the zip code configuration for a city, the zip code for a location can change but the relationship as the primary mailing address will not change. Thus, only the communication point database needs to be updated with the revised zip code information. This can be important in some industries such as the credit card rating industry in which one's credit rating is determined in part by how many times one has moved. The arbitrary redistricting of zip codes, for example, would cause one's address to change, by definition, under the old data processing methods even though the geographic location did not change. Thus, the credit rating rules used to evaluate applicants would consider the change in zip code to be a change in address, causing the credit rating for an individual to worsen—even though the person never moved. However, the system shown in FIG. 1A allows the characterization of the geographic address, i.e., the revised zip code information, to be entered without indicating that the relationship to that geographic location has changed. Thus, under the system shown in FIG. 1A, a post office that revises the zip codes for an individual would not affect the credit rating for that individual. This is yet another example of the flexibility and efficiency of the separation of data brought about by the data processing architecture shown in FIG. 1A.

As another example of the functionality that can be achieved with separated communication point data and unique party-communication point associations, one can envision all the different types of communications that can be sent for a credit card account. Thus, a monthly statement could be directed to a home address for six months of the year and a vacation address for the remaining six months of the year. Furthermore, an overcredit warning could be sent to an email address if one approaches the limit on a credit card. Furthermore, a late payment notice could be faxed to one's home address or a second late notice could be implemented by a telephone call to the individual's home phone. Each of the above communication destinations (i.e. home address, e-mail address, fax, telephone) could easily be altered and stored in the communication point database. However, associations between the party and any “address” in the communication point database can be maintained separately in a database. Thus, in comparison with traditional credit card systems in which a statement, for example, is always sent to the same address, this embodiment of the invention provides greater flexibility for communicating with a party.

Transaction

Referring again to FIG. 1A, the transaction subject area 105 is shown. The transaction subject area stores data relating to transactions conducted for a service. The transaction subject area stores a collection of data about business actions or events that impact implied financial worth or cause movement of funds from one account to another and/or impact non-financial properties (e.g., names, addresses, requests for new plastics). Thus, the transaction database can store information relating to previous purchases for a credit card account, for example. Similarly, it can store utility bill payments or billing statements for a utility service. Essentially, it stores all the data that memorializes transactions that occur for an account. In the case of the credit card industry, many of the service groups such as Mastercard and Visa have a predefined format for storing transaction information. The transaction subject area can understand these external formats, can document them as they are presented, and can broker them into internal format that can be posted to the appropriate balances on an associated account.

Balance

The balance subject area 106 in FIG. 1A is utilized to store balance information for products and accounts. Essentially, a balance is a total maintained by balance type and period for an account or account party role that serves as a mechanism for accumulating financial (debit/credit) activity. Examples of an account balance are the balance due on a utility bill or a credit card bill. This balance information can include the date of the balance, the amount of the balance, etc. The balance database keeps a balance history for each account as desired.

The balance database provides a great deal of flexibility in the types of balances that can be kept for an account. For example, a promotional balance can be used for a new product, such as a new credit card line. A late fee balance can be kept separate for a credit card as well. Similarly, an overlimit balance can be kept for an account. In addition, a big ticket promotional balance can be utilized for an account. Such promotional balances might include how much one pays toward a specific product such as a refrigerator. Thus, if a special promotional program is in existence for refrigerators, for example, the balance database can store how much money has been applied towards purchases which trigger the grant of the reward towards the refrigerator.

Thus, the balance database provides for all different kinds of balance information to be kept that can be utilized for an account or specified for a particular product line. It provides great flexibility in that the balance information can be varied and different balances can be selected for a product line.

Product

The product subject area 107 is a collection of data about a named item or service intended for sale by one party to another party for the purpose of generating revenue. Thus, parties who participate in product campaigns typically take on different roles such as those who offer products to market, those who service a product, and those who use the services provided by the product. As an example of those who offer a product to market, an issuing bank which issues credit cards to customers is one example. Similarly, a money transfer agent such as Western Union, which offers money transfer services to parties, is another example. Similarly, companies that operate as third parties for issuing and acquiring banks, such as First Data Resources and First Data Merchant Services, fall into this category as well. As an example of those who service a product, First Data Resources or any other third party processor is an example of one who performs this service. Finally, as an example of those who use the services provided by the product, a consumer using a credit card is an example of that category.

Products can be defined by party-selected component data. This replaces program-implemented features and functionality. Thus, an issuing bank party can select the components that it wishes to include as part of a new product to be offered to the purchasing public, each of which would be a separate party. This allows the issuing bank, for example, to select the interest rate, credit line, payment options, etc.

Another example of a product is a utility service. Thus, the rate for gas and electricity can be defined separately. In addition, the late fees can also be defined as separate components. The party offering such a product in this example would be the utility company while the homeowners would be the consumers.

Typically, a product will define the hierarchical nature of components, such as rollup balance, and summary statements. It can also define account balances, such as promotional balances and fees. Furthermore, it can define the treatment of those balances. In addition, it can define how the balances are affected by transactions, such as sales, payments, reversals, etc.

Products can vary by different lines of business, such as credit, retail, e-commerce, cellular, etc. A product will typically organize component data in such a way that a business person can use them, a client can understand them, and an application can process them. This allows an unlimited number of components to define a party's product. Furthermore, it allows a faster time to market for new products or to make changes to existing products. Furthermore, it provides a centralized and easily accessible database for product definitions.

Examples of products are a merchant service; a funds transfer service; a Visa™ Platinum with reward feature; a Mastercard™ Gold Card account; a retail card; an investment cash management service; a cellular transaction/billing account; and an electric utility billing service.

Rules

The final subject area illustrated in the architecture shown in FIG. 1A is the rules 108 subject area. The rules subject area is a set of data used to provide a decision and action infrastructure. A client of the service provider or the service provider itself can give a rule a definition of an action enabler within which it manages its business. Detection of business events can trigger party-defined business logic managed within the rules subject area. The rules subject area manages processing controls comprised of business logic and parameters that are translated into executable code.

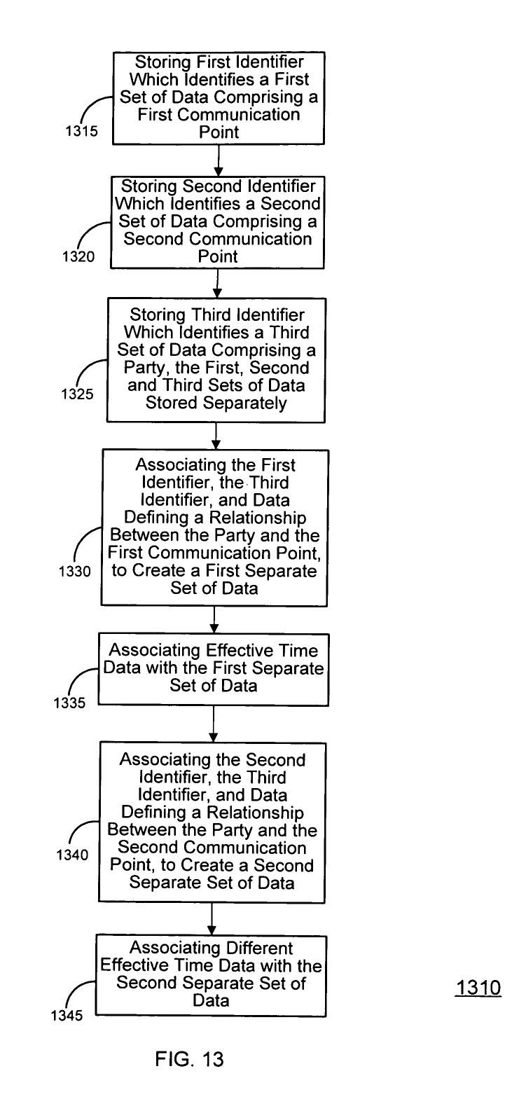

Thus, the rules database 108 can be utilized throughout the processing system depicted in FIG. 1B and FIG. 13 and to support the associations between other subject areas. For example, in the communication point usage database 132, rules can be invoked to determine when a particular party should be contacted at a communication point triggered by a business event. The rules database can be invoked to trigger a decision and resulting action depending on the formatting of the rule.

One example of use of the rules database would be as follows:

If customer's state is “CA” and the transaction is an ATM cash advance, perform

CASH FEE 1

Action Set: calculate 4% of the transaction amount

Add $1.00 to the previous result

Assess the amounts

Otherwise, if the transaction is an ATM cash advance, perform

CASH FEE 2

Action Set: calculate 4% of the transaction amount

Assess the amount.

Subject Area Associations

The various subject areas have been described above as independent databases for storing information related to a service business. As used herein, the term “database” includes any database, data store, or other organized collection of data. Relationships exist between the different subject areas and different components within the subject areas. These relationships result in associations that can be configured as databases for storing relational information between the subject area databases. While independent databases are typically used to describe the sets of data for different subject areas, it is also envisioned that separate databases could be used to store information for more than one subject area and the associations between them.

Block 130 in FIG. 1A shows a party communication point associative database. The party communication point associative database includes a grouping of data related to the party 101 database and communication point 104 database so that entries from each of those databases can be linked or coupled with one another. This allows information from the party and communication point databases to be associated so that the data stored separately can be put to use. One way to accomplish this is by associating an internal identifier for an entry from the party database 101 with an internal identifier for an entry from the communication point database 104 as an entry in the party-communication point database. Yet another internal identifier can be coupled with these two ID's, used to indicate the type of association that has been created, to form a unique entry. However, this is not necessarily required as the grouped internal identifiers can be identified and then their associated information can be obtained from the appropriate subject area database. In other words the association between the two identifiers is that the first internal identifier represents the subject and the second internal identifier represents the object of the relationship. Thus, the internal identifier for the communication point could be the subject and the identifier for the party could be the object so as to indicate that: “This specific communication point is the home address for this specific party.”

Thus, the architecture shown in FIG. 1A illustrates that a service business can be broken into different individualized subject areas. These subject areas can be kept separate from the other subject areas to allow the management of the information stored for each subject area separate and distinct from the management of the other storage area data. This permits a great deal of flexibility in the manipulation of data for a particular subject area.

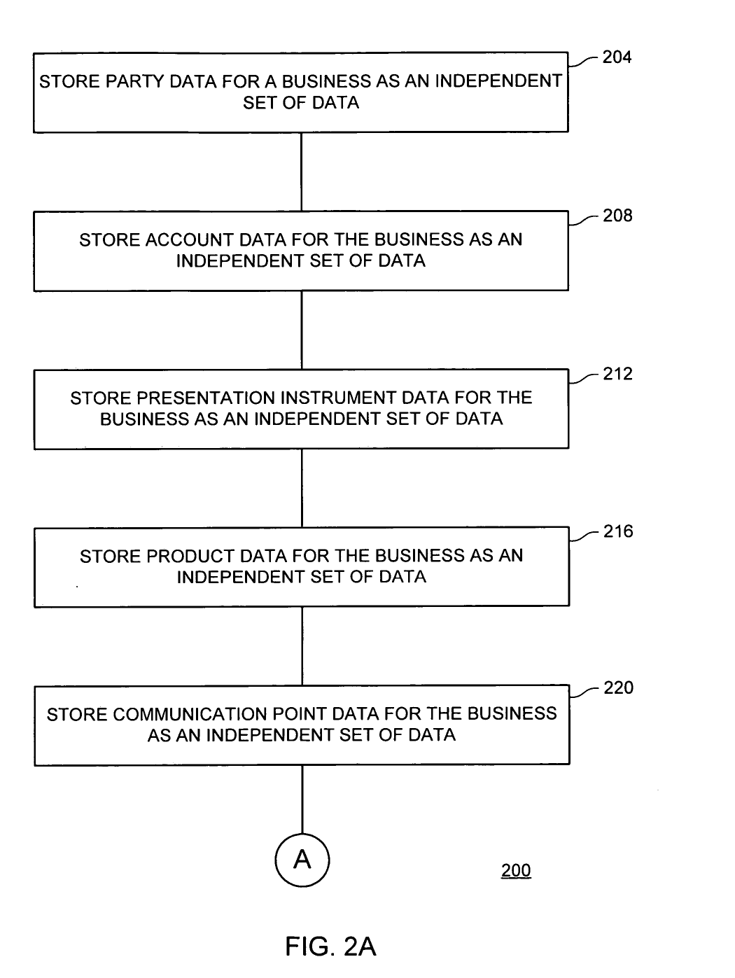

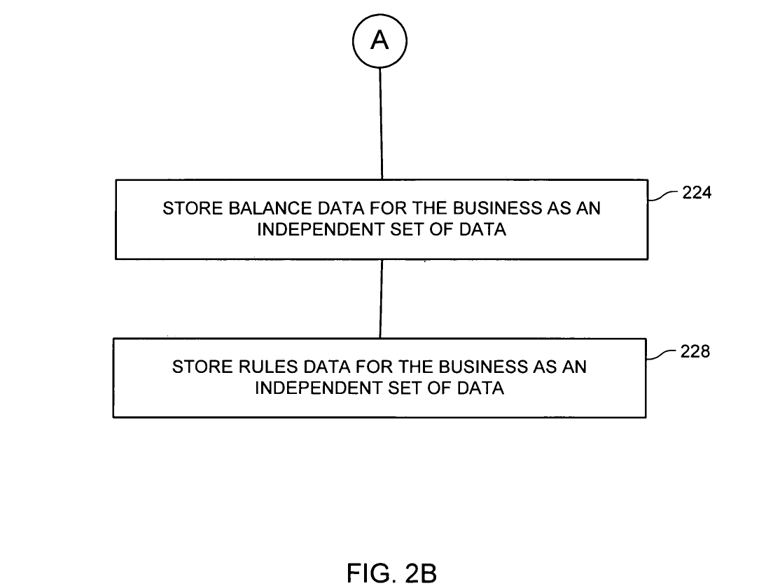

FIG. 2A illustrates the principle of dividing the architecture into separate subject areas. Namely, in flowchart 200 of FIGS. 2A and 2B, party data can be stored for a business as an independent set of data in block 204. Furthermore, in block 208, account data can be stored for the business as an independent set of data. Similarly, presentation instrument data for the business can be stored as an independent set of data in block 212 and one can store product data for the business as an independent set of data in block 216. Communication point data can be stored as an independent set of data in block 220, while balance data for the business can be stored as an independent set of data in block 224. Furthermore, rules data for the business can be stored as an independent set of data in block 228.

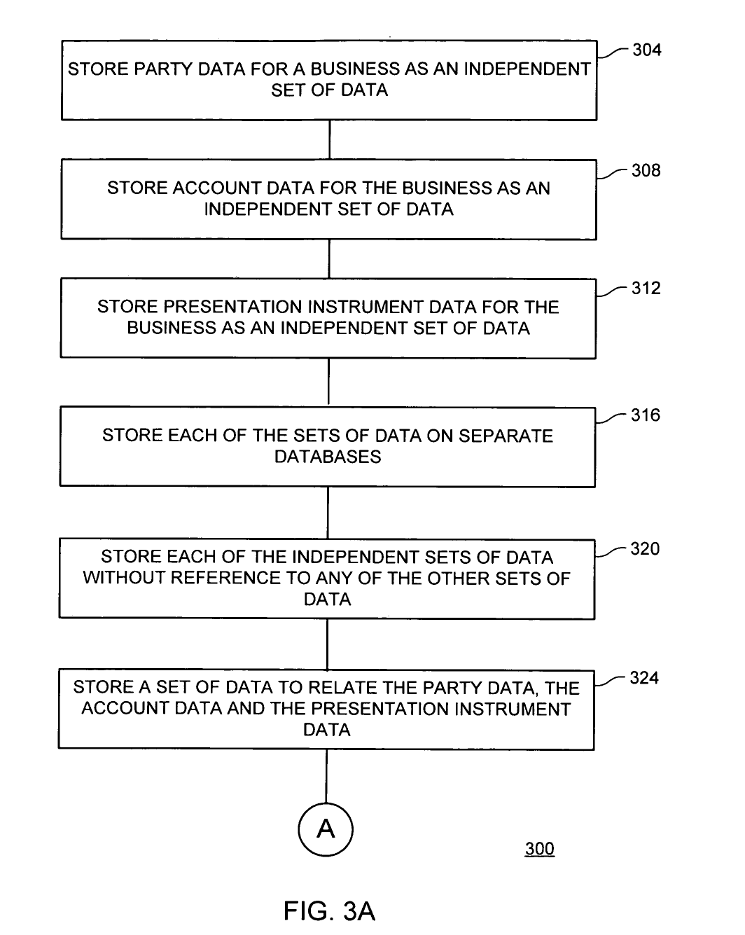

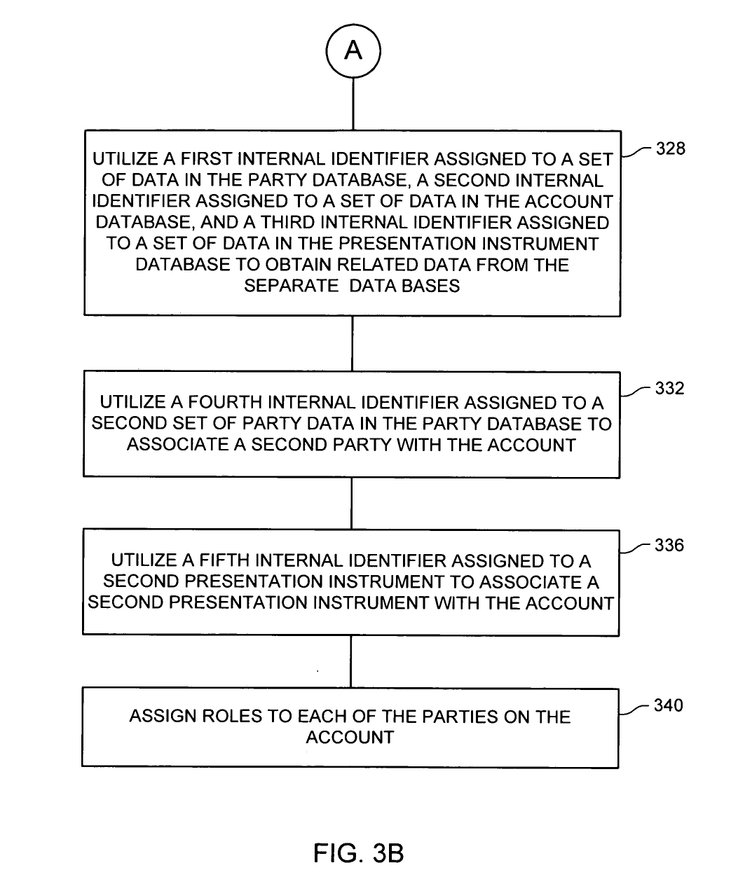

FIGS. 3A and 3B further illustrate another example of this principle. In block 304 of flowchart 300, one stores party data for a business as an independent set of data. In block 308, account data for the business is stored as an independent set of data. In block 312, presentation instrument data is stored for the business as an independent set of data. As illustrated by block 316, each of the sets of data is stored on a separate database. Storing the data on separate databases is a characteristic of this particular example and is not necessarily required if each of the sets of data can be maintained separately. In block 320, each of the independent sets of data is stored without reference to any of the other sets of data.

While party, account, and presentation instrument data sets can be stored independently, relationships between them can be established by managing associations defined by a specific service business. In block 324, a set of data to establish the relationship between party data, account data, and presentation instrument data is stored. To accomplish this, a first internal identifier is assigned to a set of data in the party database. Furthermore, a second internal identifier is assigned to a set of data in the account database, and a third internal identifier is assigned to a set of data in the presentation instrument database, as shown by block 328. These internal identifiers are grouped together, within a service business context, to form a set of internal identifiers which can be used to obtain data from each of the party, account, and presentation instrument databases for creating a specific instance of related information or set of data. A fourth internal identifier, which has been assigned to a party, can be utilized to associate a second party with the account as shown in block 332. Furthermore, a fifth internal identifier, which has been assigned to a specific presentation instrument, can be used to associate a second presentation instrument with the account as shown by block 336. Furthermore, each of the parties, i.e., the first and second parties, can be assigned a role as defined by a service provider for an account, as shown by block 340. It should be understood that a service provider can be a data processor or a client of a data processor. For example, First Data Resources of Omaha, Nebr. can act as a service provider or provide processing services for banks.

Account-Party Role

Referring to FIG. 1A, an example of a relationship between two subject areas can be seen. Namely, an association between the party subject area 101 and the account subject area 102 can be established to define the role that a party plays on an account in an account/party role database 120. This can be accomplished by associating party data with account data in the account party role database. An internal identifier generator can be utilized to generate internal IDs for each entry in each database. Thus, internal IDs can be generated for each instance of data stored in the party database as can internal IDs be generated for each set of data in the account database. The selected data elements from each database can be associated together by storing the internal IDs for each as a set of data in the account party role database along with the role which indicates the business reason for the association.

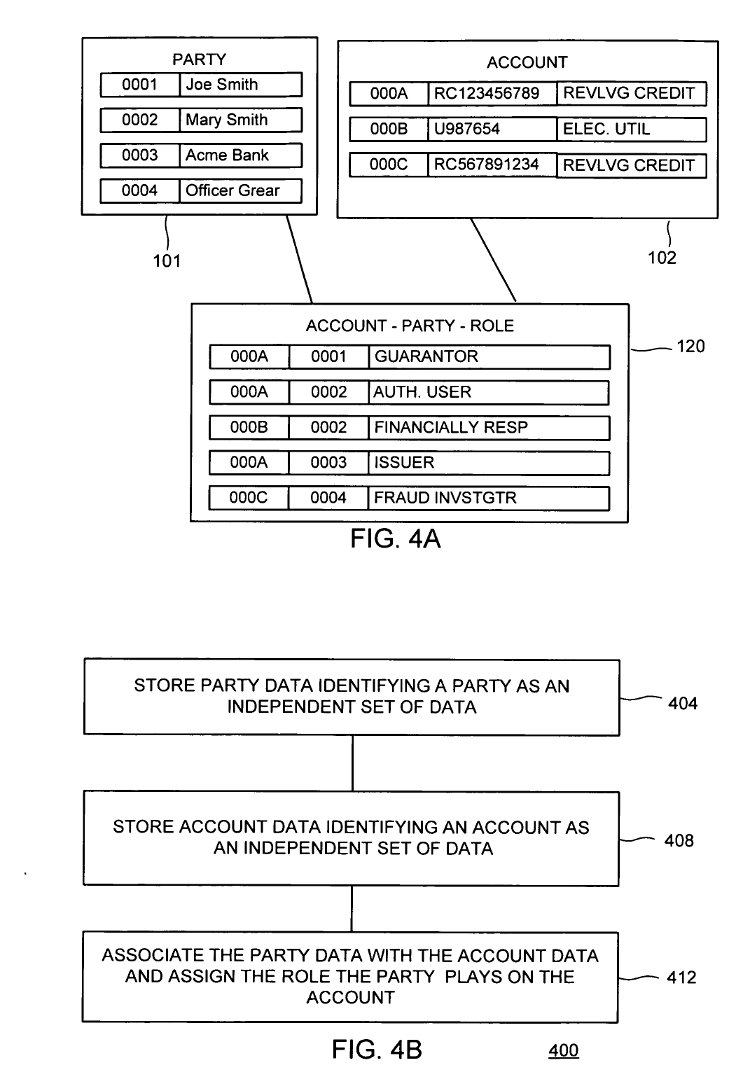

FIG. 4A illustrates an example of how data from two databases can be associated with one another. For example, a specific account in the account database 102 can be related to a specific party in the party database 101. This can be accomplished by obtaining the internal identifiers that have been assigned to the party of interest and the account of interest and storing them together as a new instance of related information in the account party role database 120. In addition to storing the internal identifiers of the party and the account, an attribute of role is added that completes the association. Thus, for example, the first entry shown in block 120 of FIG. 4A illustrates that the internal identifier 000A from the account database 102 has been associated with the internal identifier 0001 from the party database 101. Furthermore, the role information of “guarantor” has been added to indicate that the party identified as 0001 in the party database plays the role of guarantor on the account identified by the 000A entry in the account database. This is but one example of how data can be associated together to specify more detailed entries.

TABLE A

| | | | | | INTERNAL |
|---|---|---|---|---|---|
| | INTERNAL | | ACCOUNT | ACCOUNT | ACCOUNT |
| PARTY | PARTY ID | ROLE | TYPE | ID | ID |
| Joe Smith | 0001 | Guarantor | Revolving Credit | RC123456789 | 000A |
| Mary Smith | 0002 | Authorized User | Revolving Credit | RC123456789 | 000A |
| Mary Smith | 0002 | Financially Responsible | Electric Utility | U987654 | 000B |
| Acme Accounting | 0003 | Accountant | Revolving Credit | RC123456789 | 000A |
| Officer Grear | 0004 | Fraud Investigator | Revolving Credit | RC567891234 | 000C |

Table A shows a grouping of information to define the role played by a party on a specific account. Thus, in the example of a revolving credit account, different parties can be assigned different roles for a single account. For example, Table A shows that Joe Smith has been established as the guarantor on a revolving credit account with the account ID of RC123456789. Similarly, Mary Smith has been established as the authorized user role on the same account. Finally, Acme Accounting has taken on the role of being the accountant for that revolving credit account. Thus, this example shows that party data can be coupled with account data and roles can be assigned to specific parties for a single account.

Table A also shows that the association can be accomplished by obtaining the internal party ID “0001” and the internal account ID “000A” and the data entry of “guarantor” as the role and storing that set of data in the account party role database. Thus, when that instance or set of information is retrieved from the account party role database, the data that has been assigned internal party ID 0001 can be retrieved from the party database to gain identifying information for Joe Smith while the data that has been assigned internal account ID 000A can be retrieved from the account database to show that account ID RC123456789, a revolving credit account, is the account referred to for that entry. Similarly, the account party role database will store the role to be played on that account as guarantor. Thus, this is an example of how the party information and account information can be stored as separate sets of data or information, yet be utilized by another database to establish an association between two sets of information.

Table A demonstrates that, within the account party role database, multiple roles can be established for multiple parties on a single account. Furthermore, the example of Table A illustrates that relationships can be stored on the same database for different products, e.g., a revolving credit account, an electric utility account, and a different revolving credit account.

The account party role associative database is further illustrated in FIG. 4B. In flowchart 400 of FIG. 4B, block 404 shows that party data for a party is stored as an independent set of data. Furthermore, block 408 shows that account data for an account is stored as an independent set of data. Finally, block 412 shows that an entry in the party data is associated with an entry in the account data and assigned a role that the party plays on an account.

Table A further demonstrates the architecture shown in FIG. 1A. Essentially, a party, which is either an individual (Joe Smith, Mary Smith, Mike Grear) or an organization (Acme Accounting, Cross Department Store, Public Power District, Mega Telephone, First Data Corporation) contracts with another party for a service and an account is created. The terms and conditions of the products contained within that service depend on the line of business the service provider is in. For each industry-defined type of account, there are specific roles to which a party can be assigned. The business model of the service provider defines the roles and rules around which those roles are assigned. Managing the roles on the account party role database allows a relationship between the party and account to change without affecting the party or account data and creates business value. For example, as a party's role to an account is removed or changed, business value can be created by retaining the history of the relationship role the party had with the account. The history of the role is kept by changing the status and date on the account party role instance that is no longer valid and by adding a new account party instance for the new role instead of updating the existing account party role instance with the new role.

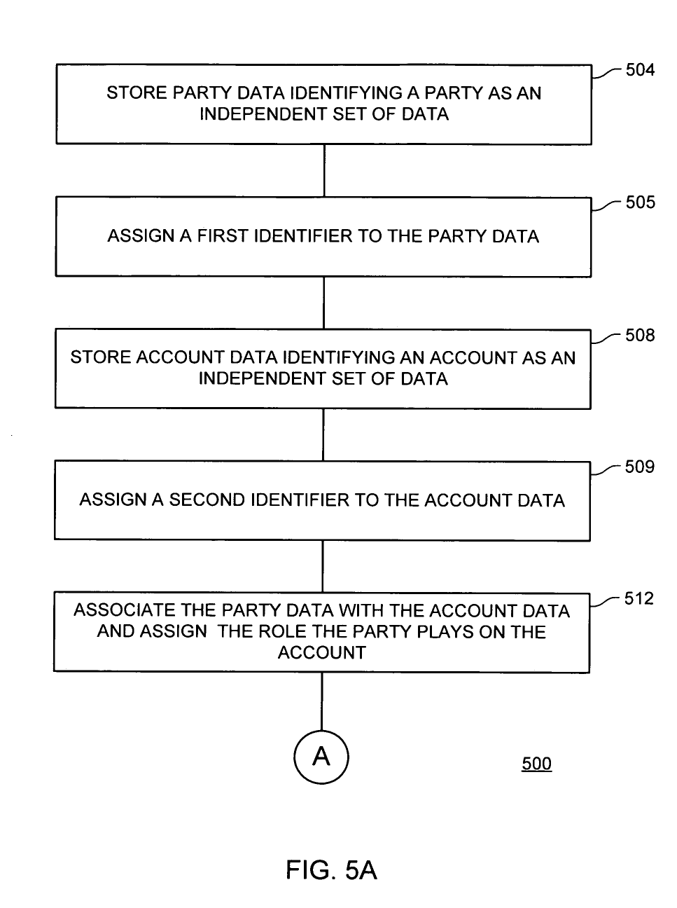

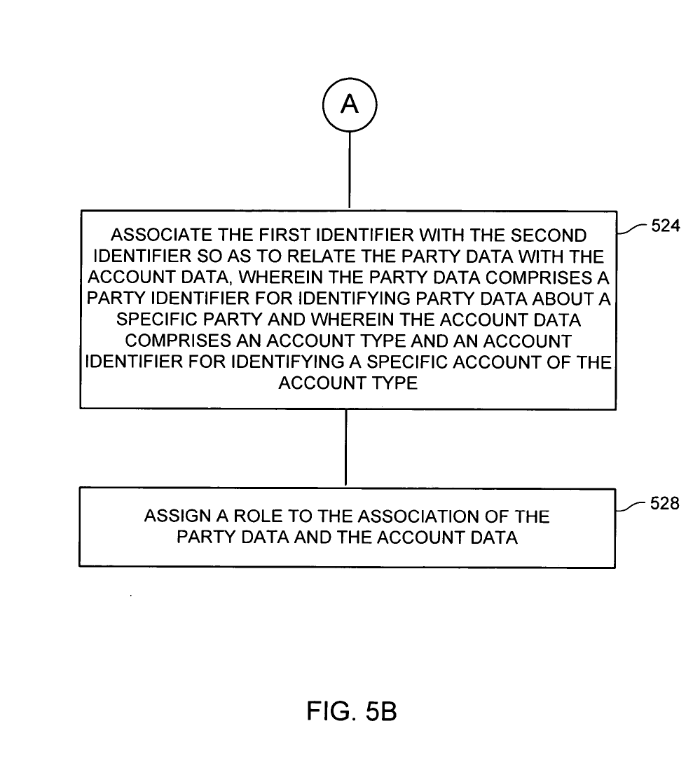

FIGS. 5A and 5B illustrate in more detail the method shown in FIG. 4B. In block 504 of flowchart 500, party data identifying a party is stored as an independent set of data. In block 508, account data which identifies an account is stored as an independent set of data. In block 505, a first identifier is assigned to the party data, while in block 509, a second identifier is assigned to the account data. In block 512, the party data is associated with the account data and assigned a role so as to identify the party as playing a role on the account. This can be accomplished by entering in the account-party role database a particular role that is assigned to a party identifier and an account identifier. For example, in block 524, the first identifier can be associated with the second identifier so as to link or relate the party with the account, wherein the party data comprises a name of the party, and wherein the account data comprises an account type and an account identifier for identifying a specific account of the account type. In block 528, a specific role is assigned to the party and account association so as to establish the role played by the party on the account. This can be accomplished by storing the first identifier, second identifier, and role as a set of data stored on the account party role database. Thus, this allows the party information to be stored and managed independently from the account data while still establishing a relationship between the two.

Party-Communication Point

FIGS. 1A and 1B illustrates another relationship between two subject areas, namely the relationship between the party subject area and the communication point subject area. A party-communication point database 130 can be established to define the relationship that an individual, organization, or organization unit has with a type of communication point. Thus, this allows one to establish whether the type of association is a home, employer, branch, headquarter, department, return address, etc regardless of the communication point type (geographic, electronic, telephonic, etc.).

This database of the party-communication point information may be useful in that it allows a service provider to understand how many of their service users have a relationship with the same communication point for marketing and cost-reduction purposes. For example, a credit card company can determine how many letters it is sending to the same communication point with advertisements. If a family of card holders resides at the same address, multiple mailings may be sent there inadvertently when one would suffice. Similarly, billing statements could be combined for the same party who has multiple accounts but is located at one communication point.

TABLE B

| | | | | | INTERNAL |
|---|---|---|---|---|---|
| | INTERNAL | RELATIONSHIP | COMM | COMM | COMM |
| PARTY | PARTY ID | TYPE | POINT ID | TYPE | POINT ID |
| Joe Smith | 0001 | Home | CP123456789 | Geographic | H0001 |
| Mary Smith | 0002 | Employer | CP787663524 | Geographic | H0002 |
| Mary Smith | 0002 | Home | CP123456789 | Geographic | H0001 |
| Acme Accounting | 0003 | Return Address | CP918273764 | Geographic | H0003 |
| Officer Grear | 0004 | Employer | CP567891234 | Geographic | H0004 |

Table B illustrates an example of a relationship of information that can be identified by a party communication point database. An entry is shown for the party Joe Smith and communication point ID CP123456789. This entry further indicates the association between the communication point and Joe Smith as home and that it is a geographic communication point. Table B further illustrates the fact that the communication point with identifier CP123456789 is used by both Joe and Mary Smith as their home address. This type of relationship is further discussed below in section B. Relationship Scheduling.

A. Party-Communication Point Database Implementation

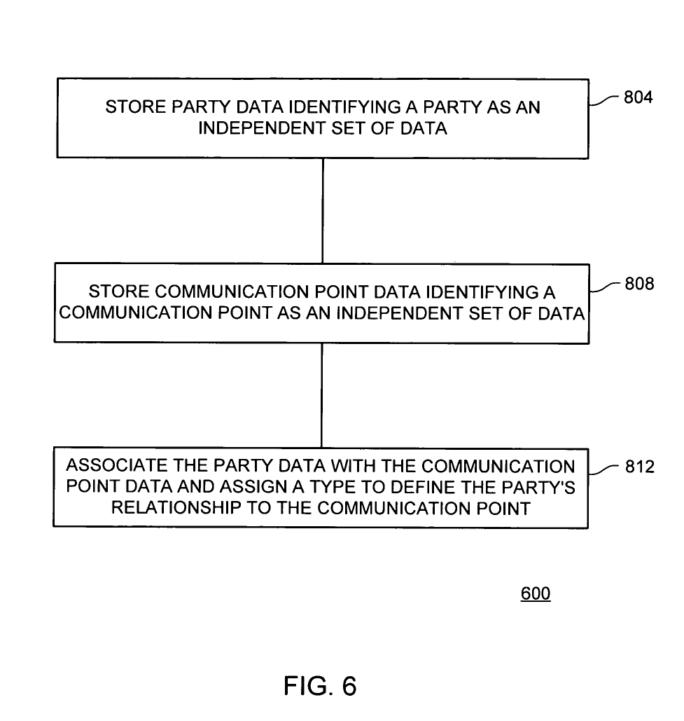

Referring now to FIG. 6, flowchart 600 illustrates a method of implementing a party communication point database. In block 804, party data identifying a party is stored as an independent set of data, such as in party database 101. In block 808, communication point data identifying a communication point is stored as an independent set of data, such as in communication point database 104. In block 812, the party data is associated with the communication point data and the association is assigned a type.

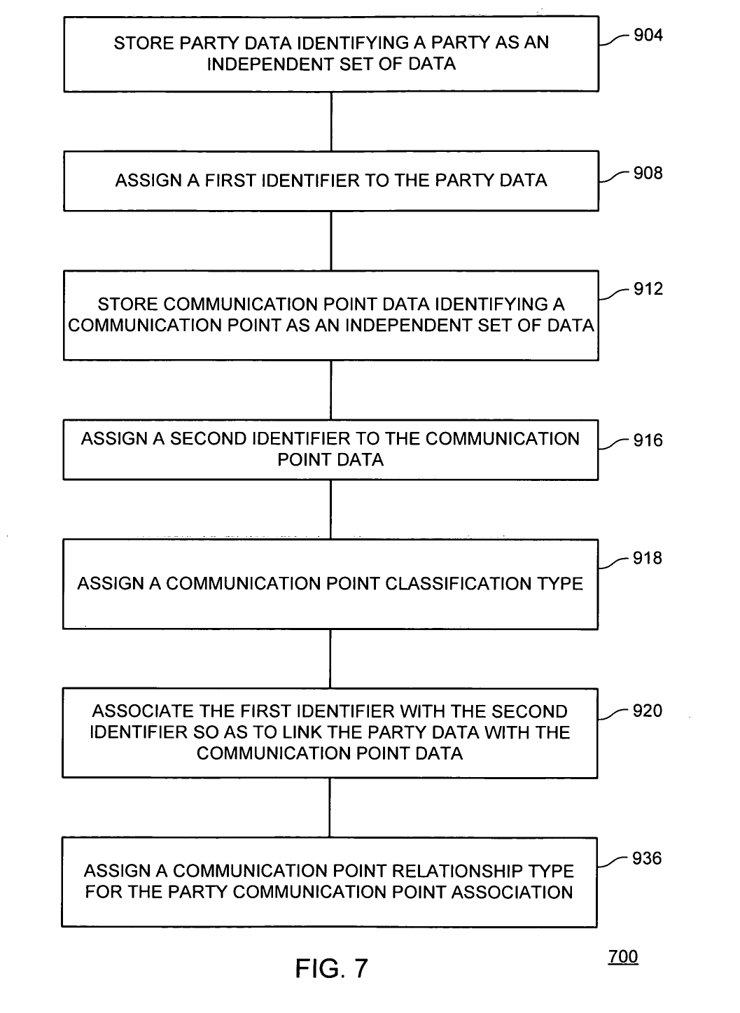

A further example is shown in FIG. 7. In block 904 of flowchart 700, party data identifying a party is stored as an independent set of data. In block 908, a first identifier is associated with data for a specific party. In block 912, communication point data identifying a communication point is stored as an independent set of data. In block 916, a second identifier is associated with the data for the communication point. In block 918, a communication point classification type is assigned to the communication point data entry. In block 920, the first identifier is associated with the second identifier as a single data entry so as to relate the specific set of party data with the specific set of communication point data and so as to identify the communication point as being assigned to the party. In block 936, a communication point relationship type is assigned to the association for the specific set of party data and the specific set of communication point data. This can be accomplished by storing the first identifier, second identifier, and communication point relationship type as a set of data stored on the party communication point type database. Thus this allows the party information to be stored and managed independently from the communication point data while still establishing a relationship between the two data entries.

B. Relationship Scheduling

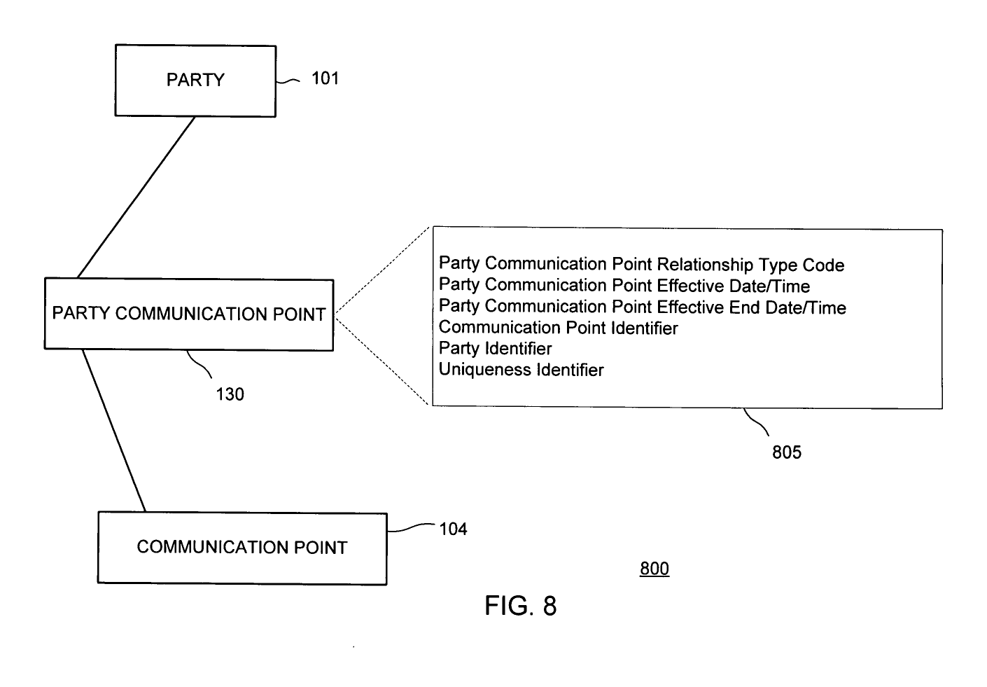

There are a variety of different data structures and associations that may be used to provide relationship information related to a party and a communication point. FIG. 8 represents a block diagram 800 illustrating how such relationship information may be organized in certain embodiments of the invention. This exemplary embodiment indicates, at block 805, the type of information or attributes that can be maintained for a Party-Communication Point relationship in a Party-Communication Point Database. As illustrated, a first identifier (Communication Point) and second identifier(Party) may be stored in the Party-Communication Point Database. In some embodiments, a Party Database, Communication Point Database, and Party-Communication Point Database may each comprise different databases.

A Party Communication Point Relationship Type may indicate whether the associated Communication Point represents a home, work, mailing, employer, branch, headquarter, department, vacation, or return address for a the associated Party. Other relationship types may be specified, as is clear to one skilled in the art. A code may be used to indicate the specified relationship, but the relationship need not be stored as a code. Once the relationship between a Party and a Communication Point has been established it may be further defined through the use of the Uniqueness Identifier. The Uniqueness Identifier, in conjunction with the Communication Point Relationship Type, allows a Party to establish multiple instances of a given type of relationship (i.e., multiple “home” communication points). The Party Communication Point Effective Date/Time and Party Communication Point Effective End Date/Time may indicate a specific start and end date, time, or a combination thereof, for the validity of the relationship, specifying a finite period of time for the validity of a relationship. However, in other embodiments, different ways may be used to indicate the effective dates (and times) of a relationship. For example, a database may be programmed to provide for input of only an effective end date, or perhaps only an effective start date. In this way, the validity of the relationship could be indefinite duration (e.g., open ended). In other embodiments, the specified period may be a subset of calendar year, and the specified period may recur annually. In some embodiments, the specified period may be specified times during the day, and the specified period may recur daily. In still other embodiments, the specified period may be specified days during the week or month, and the specified days may recur weekly or monthly.

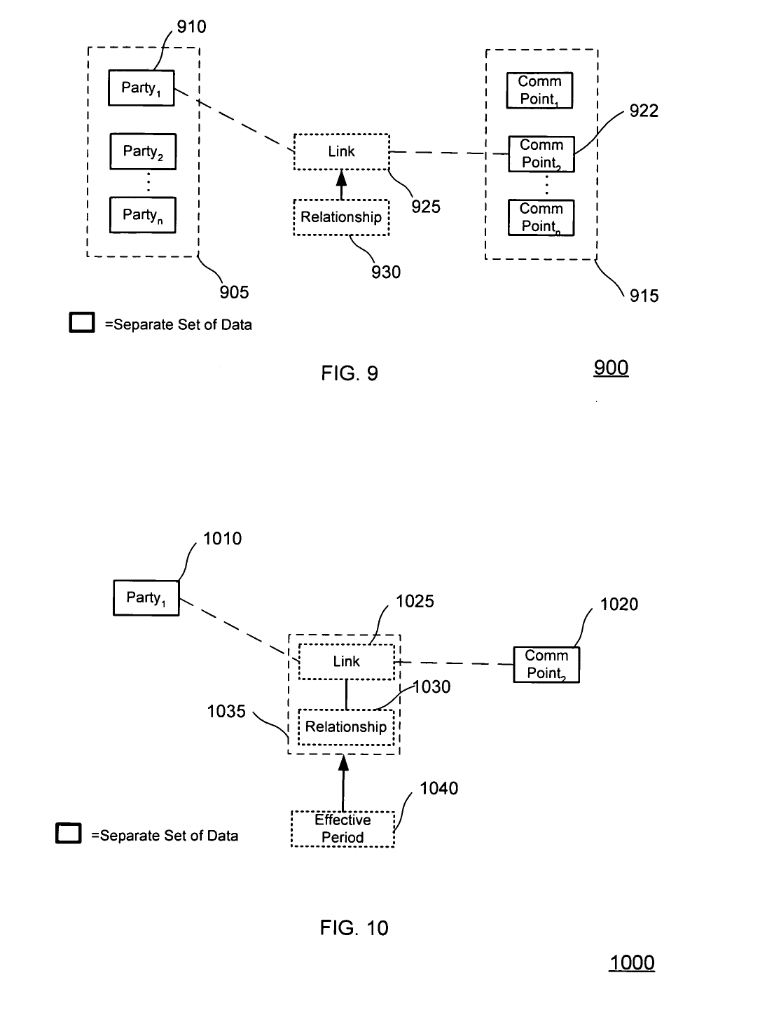

In addition to associations described above, there are further embodiments of the invention comprising other systems and methods of storing data which define a relationship between a communication point and a party. FIG. 9 illustrates a block diagram setting forth an exemplary embodiment 900 of the invention. The area 905 denoted by the dashed line may represent a Party Database, wherein Party₁ through Partyₙ are each stored as independent sets of data. The area 915 denoted by the dashed line may represent a Communication Point Database, wherein Communication Point₁ through Communication Pointₙ are each stored as independent sets of data.

A Party₁ 910, and a Communication Point₂ 922, may then be linked at block 925. This link may be structured in a number of ways. For example, as noted above, the link may simply be an association between a Party₁ 910 identifier and a Communication Point₂ 922 identifier, thereby allowing the Party₁ 910 and Communication Point₂ 922 to remain as separate sets of data. An identifier may be a pointer into a database, a unique database key providing a link to the information, or any other means known in the art which provides a pointer, link or address identifying the desired information. An identifier may be configured to allow retrieval of data to which the identifier is assigned by referencing the identifier. There are a variety of additional methods known in the art for linking separate sets of data, and any such methods may be used. At block 930, a relationship (e.g., home, work, mailing, employer, branch, headquarter, department, vacation, or return address) defining the link may then be applied. In some embodiments, there may be any number of similar links between various Party Database entries and Communication Point Database entries. However, the same Party and Communication point may have more than link, such links defining different relationships or time periods. A link may be stored in a Party-Communication Point Database, or elsewhere.

FIG. 10 illustrates a block diagram setting forth another exemplary embodiment 1000 of the invention, in which a Party₁ 1010 may be stored separately from a Communication Point₂ 1020. These independent sets of data may then be linked at block 1025, in a manner described above. At block 1030, data defining a relationship (e.g., home, work, mailing, employer, branch, headquarter, department, vacation, or return address) for the link may then be associated with the link. Data comprising the link 1025 (e.g., a Party identifier and Communication Point identifier), and data defining the relationship identified by the link 1030, may be stored together as an independent set of data identified, within the dashed area designated by reference numeral 1035. This dashed area 1035 may, therefore, represent a party communication point type database. Data which identifies an effective period 1040 (finite, or indefinite, as described above) may also be associated with the link 1025, the defined relationship 1030, or the association thereof 1035. Effective period data 1040 may also be stored with data comprising the link 1025 and data defining the relationship identified by the link 1030, this data stored together as an independent set of data.

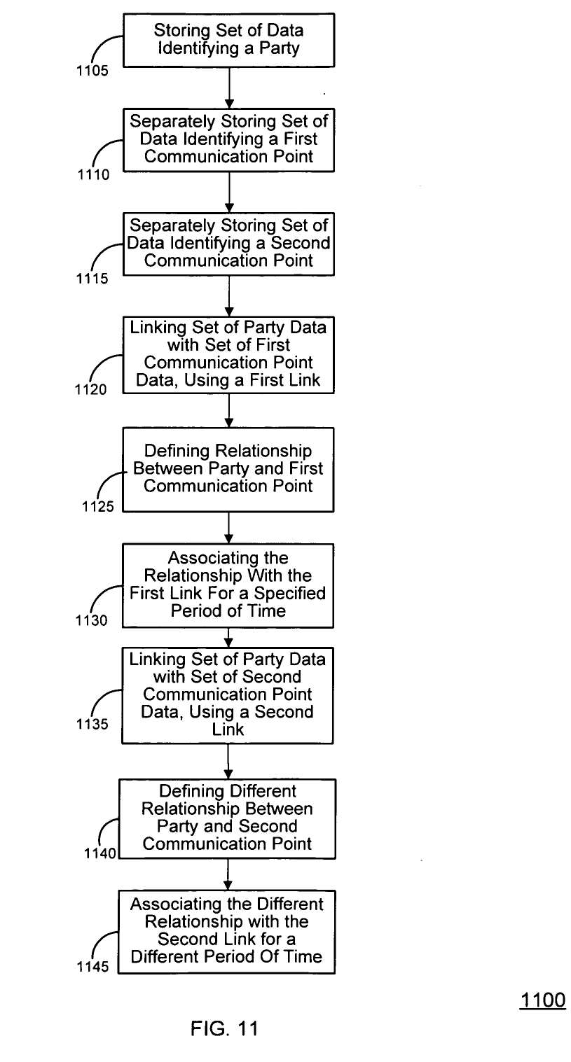

Exemplary Embodiments˜Relationship Scheduling: A further understanding of the invention may be achieved with the following explanation of various exemplary embodiments. FIG. 11 sets forth a first exemplary embodiment 1100 of the invention. At block 1105, set of data identifying a party may be stored. At block 1110, a set of data identifying a first communication point may be stored separately from the set of party data. At block 1115, a set of data identifying a second communication point may be stored separately. Therefore, in some embodiments, each set of data identifying a party or a communication point may be stored independently.

At block 1120, the set of party data is linked with the set of first communication point data, using a first link. At block 1125, a relationship between the party and the first communication point may be defined, and at block 1130 the relationship may be associated with the first link for a specified period of time. At block 1135, the set of party data may be linked with the set of second communication point data, using a second link. At block 1140, a relationship between the party and the second communication point may be defined, and at block 1145 the relationship may be associated with the second link for a different period of time.

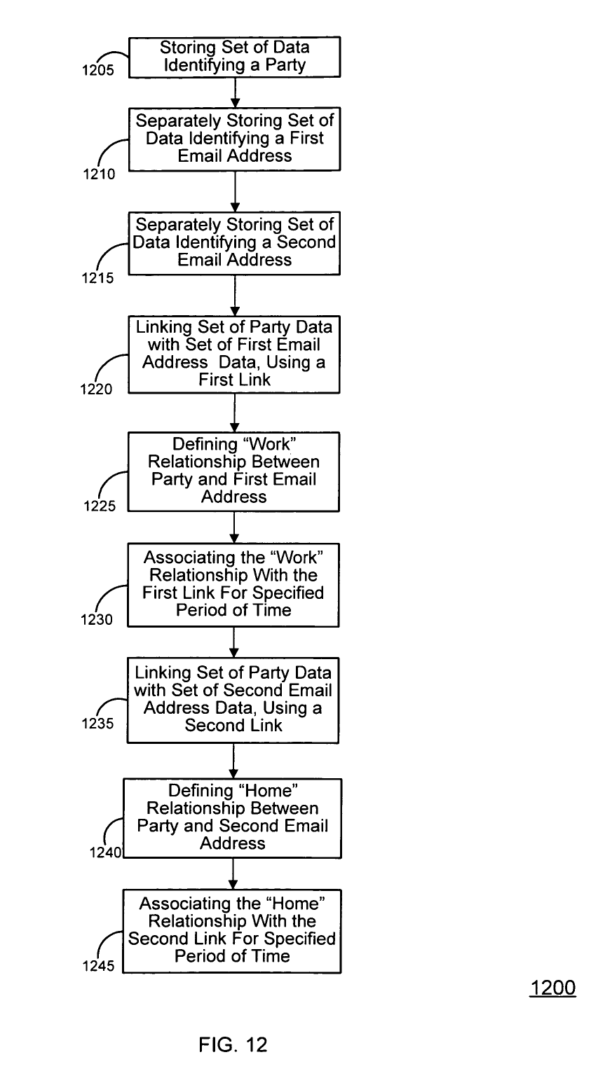

FIG. 12 sets forth an additional exemplary embodiment 1200 of the invention, applying a number of principles outlined above. At block 1205, set of data identifying a party may be stored. At block 1210, a set of data identifying a first email address may be stored separately from the set of party data. At block 1215, a set of data identifying second email address may also be stored separately. The email addresses may comprise communication points, which may be stored in a Communication Point Database.

At block 1220, the set of party data may be linked with the first email address data, using a first link. At block 1225, an occurrence of a “work” relationship between the party and the email address may be defined. Thus, in certain embodiments, the email address could represent the communication point for the party when the party is at a specific work place. At block 1230 the relationship may be associated with the first link for a specified period of time. This specified period of time could be from a start date/time to an end date/time (e.g., when the party is at work). Those skilled in the art will recognize the flexibility that can be achieved with this type of data structure, as well as the variety of different ways this type of structure could be implemented.

At block 1235, the set of party data may be linked with second email address data, using a second link. At block 1240, an occurrence of a “home” relationship between the party and the second email address may be defined. Thus, in certain embodiments, the second email address could represent the communication point for the party's “personal” email correspondence. At block 1245, the relationship may be associated with the second link from a start date/time to an end date/time (e.g., when a party is at home). The relationship may be associated with the second link upon an effective date/time, as well. The effective period can be of a finite or indefinite duration (e.g., it can be open ended, and have no ending date). Also, the effective period may recur regularly.

FIG. 13 illustrates an additional exemplary embodiment 1310 of the invention, wherein the invention may be implemented using identifiers associated with independent sets of data. At block 1315, a first identifier is stored which identifies a first set of data comprising a first communication point, and at block 1320 a second identifier is stored which identifies a second set of data comprising a second communication point. At block 1325, a third identifier is stored which identifies a third set of data comprising a party. The first, second, and third sets of data may be stored separately from each other.

At block 1330, the first identifier, the third identifier, and data defining the relationship between the party and the first communication point are associated with each other. This association may create a first separate set of data, stored separately from the first set of data and the second set of data. At block 1335, effective time data may be associated with the first separate set of data thereby create a limited effective time period for the validity of the relationship between the party and the first communication point.

At block 1340, the second identifier, the third identifier, and data defining the relationship between the party and the second communication point are associated with each other. The relationship specified may be the same, or different, than the relationship between the party and the first communication point. This association may create a second separate set of data, stored separately from the first set of data, the second set of data, and the first separate set of data. At block 1345, different effective time data may be associated with the second separate set of data thereby create a different effective time period for the validity of the relationship between the party and the second communication point.

Communication Point Usage

Referring now to Table C, the relationship of communication point usage can be better understood.

TABLE C

| PARTY | ROLE | ACCOUNT TYPE | ACCOUNT ID |
|---|---|---|---|
| Joe Smith | Guarantor | Revolving Credit | RC123456789 |
| Joe Smith | Guarantor | Revolving Credit | RC123456789 |
| Mary Smith | Authorized User | Revolving Credit | RC123456789 |
| Mary Smith | Payor | Electric Utility | U987654 |
| Acme | Accountant | Revolving Credit | RC123456789 |
| Accounting | | | |
| Officer | Fraud | Revolving Credit | RC567891234 |
| Grear | Investigator | | |

USES

| | RELATIONSHIP | COMM POINT | |
|---|---|---|---|
| PARTY | TYPE | ID | COMM TYPE |
| Joe Smith | Home | CP123456789 | Geographic |
| Joe Smith | Home | CP123456789 | Geographic |
| Joe Smith | Home | CP123456789 | Geographic |
| Mary Smith | Employer | CP787663524 | Geographic |
| Acme Bank | Return Address | CP918273764 | Geographic |
| Officer Grear | Employer | CP567891234 | Geographic |

Usage Type
Plastics
Statements
Letters
All Communications
Statement
Fraud Contact

The communication point usage relationship allows a party communication point to be associated with an account party role. The account party role entries indicate the role that a specific party will play on an account. The party communication point indicates a communication point for a particular party. By linking entries for the party communication point and the account party role, a specific usage can be added as well. Thus, a type of communication can be indicated. Table C illustrates three sets of data, the party/communication point data, and the party/account role set of data, and usage types for these cross-referenced entries. For example, the first entry in the party/account role database is for Joe Smith as guarantor on an account. Furthermore, the first entry in the party/communication database is for Joe Smith's geographic home location. The first entry for the usage type is plastics. Thus, Table C illustrates that any communications relating to plastics, such as new credit cards, are sent to Joe Smith at his geographic home address. Similarly, the second entry in each of the three sets of data indicates that statements are sent to Joe Smith as guarantor to his home geographic address. The third entry indicates that any letters for Mary Smith in her role as authorized user on the revolving credit account RC123456789 are to be sent to Joe Smith's home geographic address. However, the fourth entry indicates that any communications to Mary Smith in her role as the payor for electric utility account U987654 are to be sent to Mary Smith's employer's geographic address. The fifth entry indicates that any statement communication for Acme Accounting as accountant on revolving credit account RC123456789 are to be sent to the geographic return address entry for Acme Accounting identified by communication point ID CP918273764. The sixth entry indicates that any fraud contacts for revolving credit account RC567891234 should be sent to Officer Grear in his role as fraud investigator at his employer's geographic address indicated by communication point ID CP567891234.

The example of Table C indicates that, once entries are established in different relationship databases, they may be combined for further relationships. Thus, an entry in the account party role database 120 can be associated to an entry in the party communication point database 130 to establish a communication point usage entry in communication point usage database 132. Again, internal identifiers can be associated with each entry in the account party role database and the party communication point database to associate instances (i.e., data) from each of those databases. Furthermore, each of those associations can include additional information such as the usage type (plastics, statements, letters, all communications, return address, fraud contacts, etc.) for that particular entry.

Party Subject Area

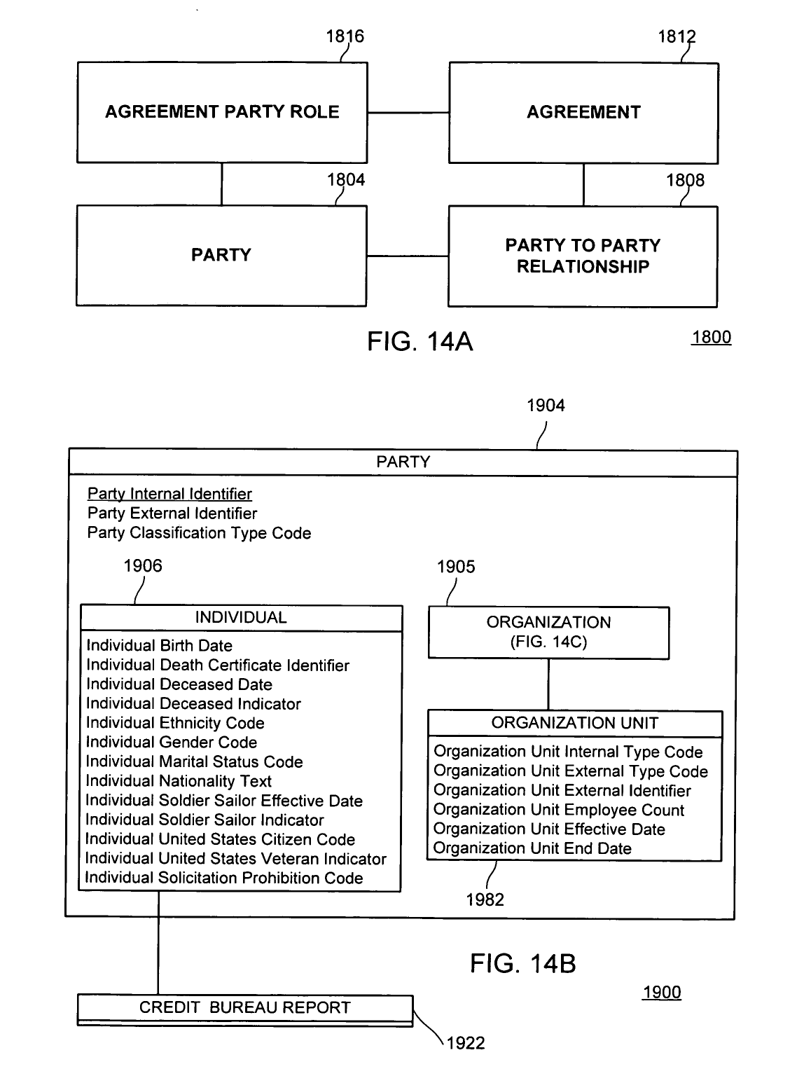

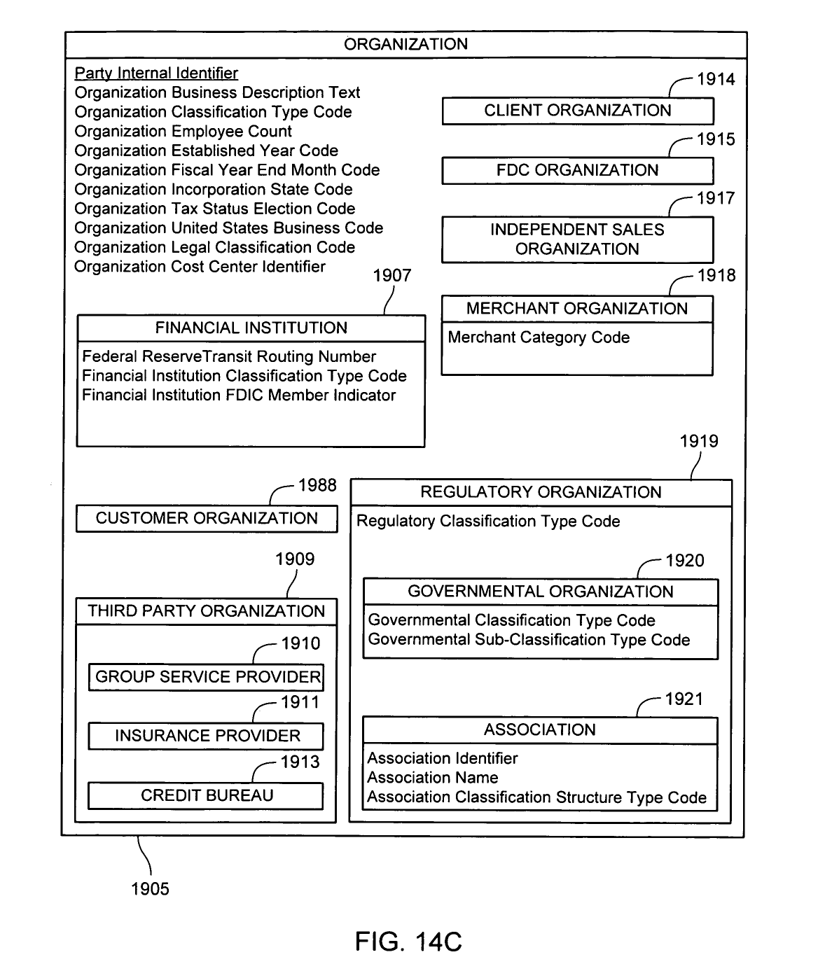

The party subject area, which is a collection of data about individual(s), organization(s), or organization unit(s) needed by a service provider to carry out business operations on behalf of itself and/or its client(s) is illustrated in more detail in FIGS. 14A, 14B, and 14C. FIG. 14A illustrates a system 1800 having four databases: a party database 1804, an agreement database 1812, an agreement-party role database 1816, and a party to party relationship database 1808. In this embodiment, the party database 1804 is associated with the agreement database 1812 via the agreement party role association database 1816. Similarly, the party database 1804 is associated to itself via a party to party relationship database 1808 and the party to party relationship database is related to the agreement database 1812. FIGS. 14B and 14C illustrate more detailed embodiments of some of these databases. In FIG. 14A, the Party database 1804 and the Agreement database 1812 are coupled with an Agreement Party Role database 1816. Similarly, the Party database and the Agreement database are also coupled with the Party to Party Relationship database 1808.

A party is an individual, organization, or organization unit that a service provider needs to have information about in order to carry out business operations on behalf of itself and/or its clients. For example, First Data Resources (FDR), a data processing company in Omaha, Nebr. constitutes a party. Likewise, its parent company First Data Corporation and sister companies such as Western Union or Telecheck are also considered parties. Client organizations that contract with FDR for processing services are also parties. Furthermore, an individual or organization that is a customer of one of FDR's clients and one of FDR's clients and who has a role on an account processed by First Data Resources is also considered a party. Other examples include parties such as a contact person at a merchant organization, a credit bureau that receives account status information to be incorporated in a credit bureau report, and a vendor that provides plastics.

The party subject area database can store a collection of information needed to manage data about individuals and organizations who have a direct or indirect relationship with one another or with a service provider. The party subject area can include information such as: identification data (names, identifiers, biometric information), demographic information, relationships to other individuals, roles on agreements or accounts, and language preferences of the parties.

Organization of the party information can help service providers to accomplish different tasks, such as: keeping track of their customers, making changes to the party data quickly and easily, managing customer relationships, and complying with regulations such as recent privacy regulations. Furthermore, from the perspective of a third party data processing provider, such as First Data Resources of Omaha, Nebr. and First Data Corporation the organization of the party information can help in: responding to changing client needs, providing structures to facilitate new types of businesses, supporting client defined products with new types of parties, and supporting new types of party relationships, agreements, and roles.

A party is defined within the business context of the entity that establishes it. For example, third party processors are capable of processing transactions on accounts for many different banks that offer credit cards. In some cases, a person may have one credit card with Bank A and a second credit card with Bank B. In such an instance, that person is recognized by the third party processor as a first entity for Bank A and a different entity for Bank B. Alternatively, a person may have more than one credit card issued by the same bank. In that instance, the person is a single entity used by the processing system to process the different credit card accounts issued by that bank. Thus, for a third party processor that processes transactions for multiple banks, a person can be represented as different entities—e.g., a different entity for each bank. Furthermore, for the person who has more than one account at a single bank, a single entity can be used for the party data to process the transactions—i.e., one entity for multiple accounts.

FIGS. 14B and 14C illustrate a more detailed view of the party subject area according to system 1900. First, block 1904 in FIG. 14B illustrates the type of information that can be maintained about a particular party. For example, a “Party Internal Identifier” can be generated to identify the entry storing party information for a specific party. Within a data processing system operated by a third party processor, for example, the internal identifier can uniquely identify the party within the context of the data processor's business operations whereas the “Party External Identifier” can be assigned by the client to identify the party within the context of the client's business operations. In other words, the “Party External Identifier” can be an identifier within the client organization as opposed to the internal identifier which is used to internally track the party entry within the data processing system. Block 1904 also shows that a “Party Classification Type Code” can be assigned to represent the highest level of categorization of the Party. Examples are codes to identify the Party as: an individual, an organization, or an organizational unit. Further information for an individual, an organization, and an organization unit can be maintained as indicated by blocks 1906, 1905, and 1982, respectively.

Block 1906 indicates the type of information or attributes that can be maintained for an individual. An individual is a person that the system needs to have information about in order to carry out business operations. For example, the individual's birth date, death certificate identifier (i.e., an externally defined identifier of the death certificate issued by a geopolitical organization to certify the death of the individual), and date the individual died can be maintained. In cases where the death certificate has not yet been received, an indicator designating whether the individual is dead can be recorded. In addition, a code representing the ethnic classification used by an individual can be recorded, as can an individual gender code representing the sex of the individual (e.g., “male”, “female”, or “Gender not provided”). A code representing the marital status of the individual can be recorded as part of the entry, as well, such as common law marriage, divorced, separated, head of household, married, domestic partner, single, widowed, or unknown. In addition, a field can be used to record the national heritage of an individual, such as German, Italian, Scandinavian, etc. This can be a useful field for applying the requirements of increased government scrutiny of financial accounts, such as the heightened scrutiny applied by the Patriot Act. The effective date that the individual becomes eligible for Soldier and Sailor Act benefits can be recorded as can an indicator indicating whether the individual is currently eligible for benefits under the Soldier Sailor Act. In addition, a code representing a general categorization of an individual's citizenship can be recorded, such as the individual is a US citizen, the individual is not a US citizen, the individual is a citizen of another country as well as a citizen of the US, or the individual citizenship is not provided. Also, an indicator can be used to designate whether the individual is a veteran of one of the military branches. Also, an “Individual Solicitation Prohibition Code” can be used to indicate whether an individual can be contacted about purchasing new or additional products. The values for this code may indicate: 1) Yes, you may solicit and telemarket the customer; 2) Do not solicit this customer; 3) Do not telemarket this customer.

In FIG. 14C block 1905 shows the type of information, in the form of attributes, that can be maintained for an organization. An organization is created within the context of the business requirements of the Party that defines it. For example, in the context of a third party processor such as First Data Corporation, an organization could include any First Data company, such as First Data Merchant Services, Telecheck, and Western Union; a client organization, such as an issuer bank ABC or an acquirer bank XYZ; a merchant organization (e.g., Mom and Pop's Diner or Large Retail Conglomerate); a regulatory organization (e.g., Visa, MasterCard, State of Nebraska, or Securities Exchange Commission); a third party organization (e.g., vendor organization, network provider, or credit bureau); or an organizational unit (e.g., a division of an organization that is not a legal entity in and of itself, such as a division, department, or branch).

Block 1905 shows examples of attributes that can be stored as part of an entry for an organization. For example, “Organization Business Description Text” can be maintained for use as party-defined text describing the nature of the business. Furthermore, an “Organization Classification Type Code” can be used to classify the organization as belonging to a particular class, such as an internal division or subsidiary of the third party processor (e.g., in the case of First Data Corporation: First Data Corporation, First Data Resources, TeleCheck, and Western Union), a financial institution (e.g., a bank or credit union), a merchant organization (e.g., a department store, a Mom and Pop store, a mail order company), a regulatory organization (e.g., VISA, MasterCard, IRS, or Federal Reserve), a third party organization (e.g., a vendor, credit bureau, or law firm), a client organization (e.g., an organization that can take on the role of Issuer or Acquirer), an independent sales organization, or a customer organization (e.g., a commercial card customer). Another attribute that can be stored as part of the entry is an “Organization Employee Count” which is a count of the persons employed in an organization as specified by the Party that defined the organization. This field can be used, for example, to provide a discount rate to employees when the employer has a certain number of employees. Other attributes that can be stored as part of an organization entry include: a code representing the year the organization was formed; a code representing the month in which the organization's accounting cycle closes for determining profits or losses for the year; a code representing the state in which the organization was chartered; a code describing the tax status of the organization for filing state and federal taxes; a code representing whether the organization was formed or chartered in the United States; a code representing the legal structure of the organization, or an “Organization Cost Center Identifier” that indicates the accounting area where costs for the organization are to be allocated.

Block 1905 shows further sub-blocks which categorize additional information about different types of organizations. For example, block 1907 shows data that is specific to a financial institution. A financial institution is an organization that collects funds from the public to place in financial assets. For example, a bank, a savings and loan association, a credit union, and an insurance company are examples of financial institutions. Examples of information that can be stored for a financial institution include a “Federal Reserve Transit Routing Number”, a “Financial Institution Classification Type Code” (e.g., depository or non-depository institution), and a “Financial Institution FDIC Member Indicator” (i.e., designating whether the financial institution is a member bank of the FDIC).

Block 1988 shows data that can be maintained for a customer organization, such as any organization whose primary relationship with a third party processor is as a customer of a client of the third party processor. An example of this is an organization that has a commercial card agreement with an ABC Bank—where ABC Bank is a client of the third party processor. An example of a code that can be maintained as part of the entry for a customer organization is a customer organization classification type code that describes the customer as being a commercial card customer, or a fleet customer, etc.

Block 1909 illustrates data can be maintained for a third party organization. A third party organization is typically a supplier or service provider such as a material vendor, an insurance vendor, a rewards fulfillment vendor, a software vendor, a hardware vendor, a co-brand partner, an information vendor, a data entry vendor, a marketing vendor, a collection vendor, and a voice response unit support vendor. As examples of third party organizations, blocks 1910 group service provider, block 1911 insurance provider, and block 1913 credit bureau show that data specific to each classification of third party organizations can be maintained.

Block 1914 shows that data can be maintained that is specific to a party that is a client. For example, a “Client Organization Classification Type Code” can be used to identify the client as an acquirer, an issuer, or both an acquirer and an issuer.

Block 1915 shows that data can be maintained for the data processing company's own organizations. In this example, data can be maintained that is specific to organizations that are part of First Data Corporation (FDC) entity.

Block 1917 shows that data that is specific to an independent sales organization can be maintained.

Block 1918 shows that data that is specific to a merchant organization can be maintained. A merchant organization can be an organization that accepts presentation instruments as payment in exchange for goods or services provided. An example of an attribute that could be maintained about a merchant organization is the “Merchant Category Code” that designates the line of business or the type of service that the merchant organization provides.

Block 1905 also shows that data can be maintained for regulatory organizations in block 1919. A regulatory classification type code attribute is provided to categorize the regulatory organizations. The two example classifications shown in block 1919 are governmental organizations and industry associations. In block 1920, shows that a “Governmental Classification Type Code” can be used to classify a governmental organization, for example, as an international organization, a national organization, a state organization, etc. Likewise a governmental sub-classification code can also be used to further categorize the governmental organization. Examples of the sub-classification includes such things as an agency, a bureau, a military organization, etc. Similarly, block 1921, association, provides examples of attributes that can be maintained specifically about an association. Examples include such things as an “Association Identifier”, an “Association Name”, and an “Association Classification Structure Type Code.”

Block 1982 illustrates how data can be maintained for an organization unit according to one example. The organization unit is a subset or division of an organization as specified by the party that defined it. A significant characteristic of an organization unit is that it is not chartered or recognized by any governmental organization as a legal entity and therefore cannot enter into legal contracts. For example, an organization unit may be a division or department of a legal entity. Another example might be a subset of a merchant organization, such as a store. Attributes can be used to characterize an organization unit. An “Organization Unit Internal Type Code” is a code defined by the data processor that represents the categorization of the organization unit (e.g., business unit, operating division, operations group, division, department, office, client defined). An “Organization Unit External Type Code” is a code representing the categorization of the organization unit as specified by a party external to the data processor (e.g., a client defined code for a business unit, operating division, operations group, division, department, office or branch). An “Organization Unit External Identifier” is an identifier for the organization unit as specified by a party external to the data processor (e.g., DIV-01 or DEPT-HR). An “Organization Unit Employee Count” is a count of the persons employed in an organization unit as specified by the party that defined the organization unit. For example, this field can be used to determine whether employees of an organization are entitled to get a certain discount rate with a partner organization if a minimum number of employees are required for the discount to apply. An “Organization Unit Effective Date” can be used to define the date an organization unit is valid for use within the context of the business of the party that defined it (e.g., the date the human resources department is valid in a growing company that adds a human resources department). Similarly, an “Organization Unit End Date” can be defined to indicate the last date that the organization unit is valid for use within the context of the business of the party that defined it. A credit bureau report can be generated for a specific party. For example, block 1906 which maintains information for an individual can be related to credit bureau report block 1922.

Account Subject Area

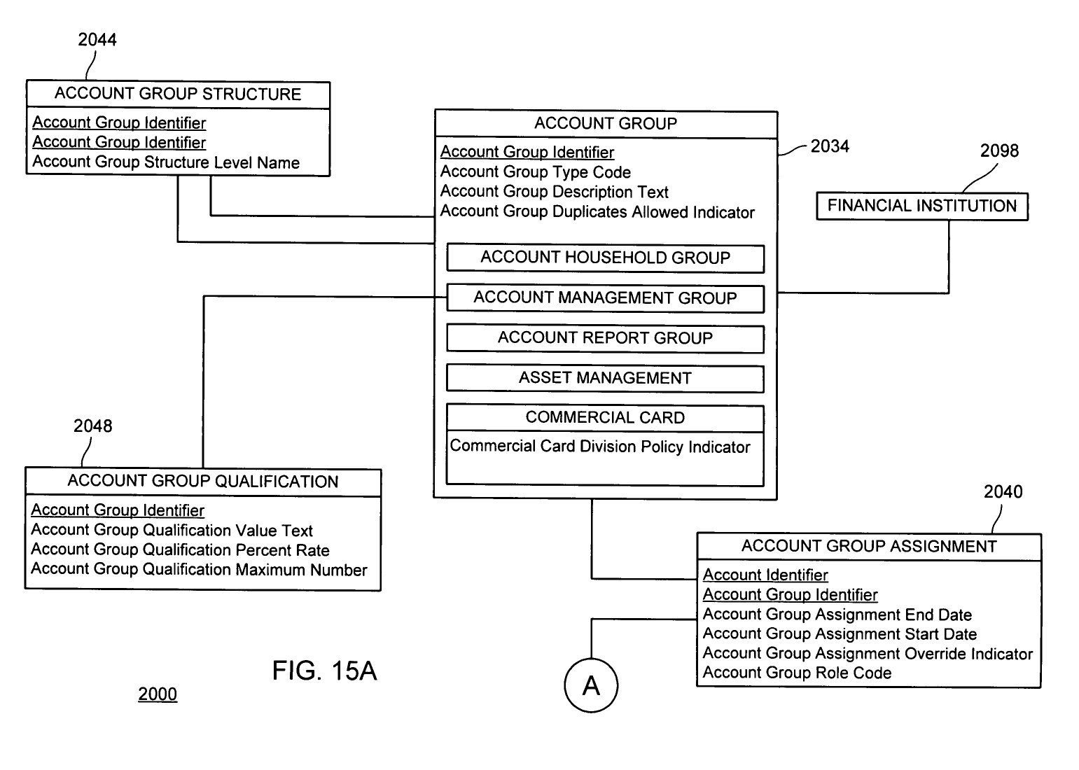

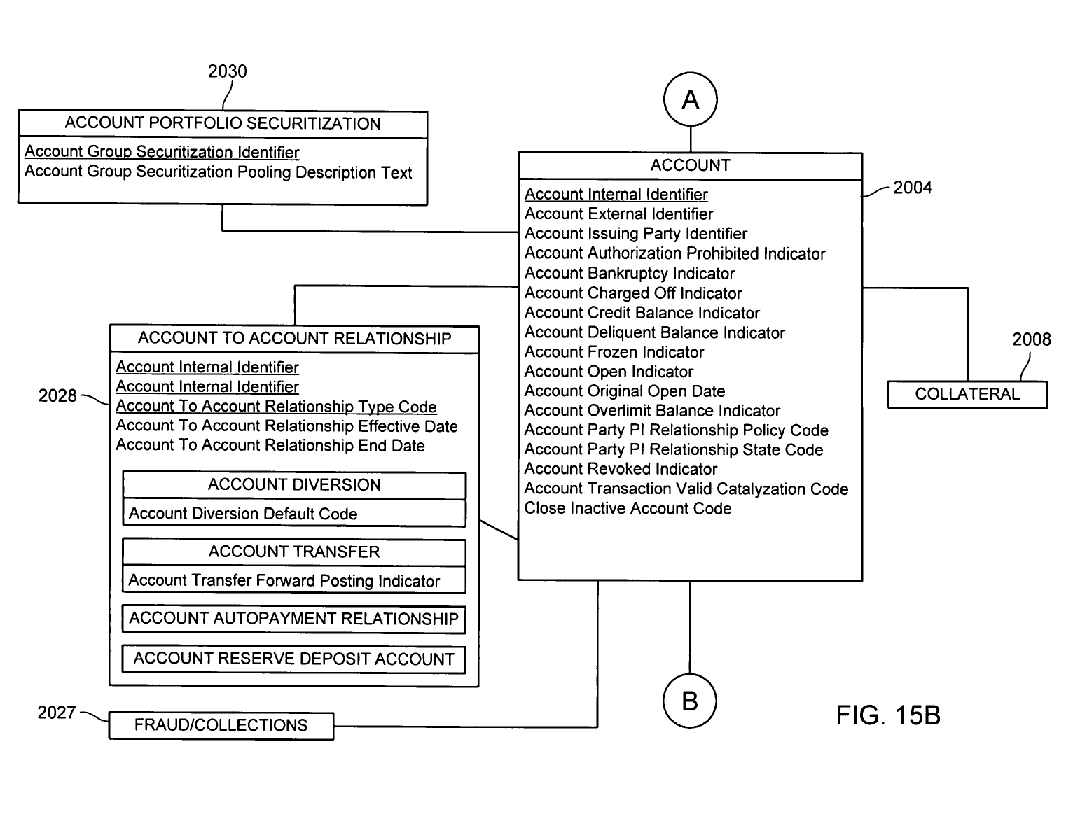

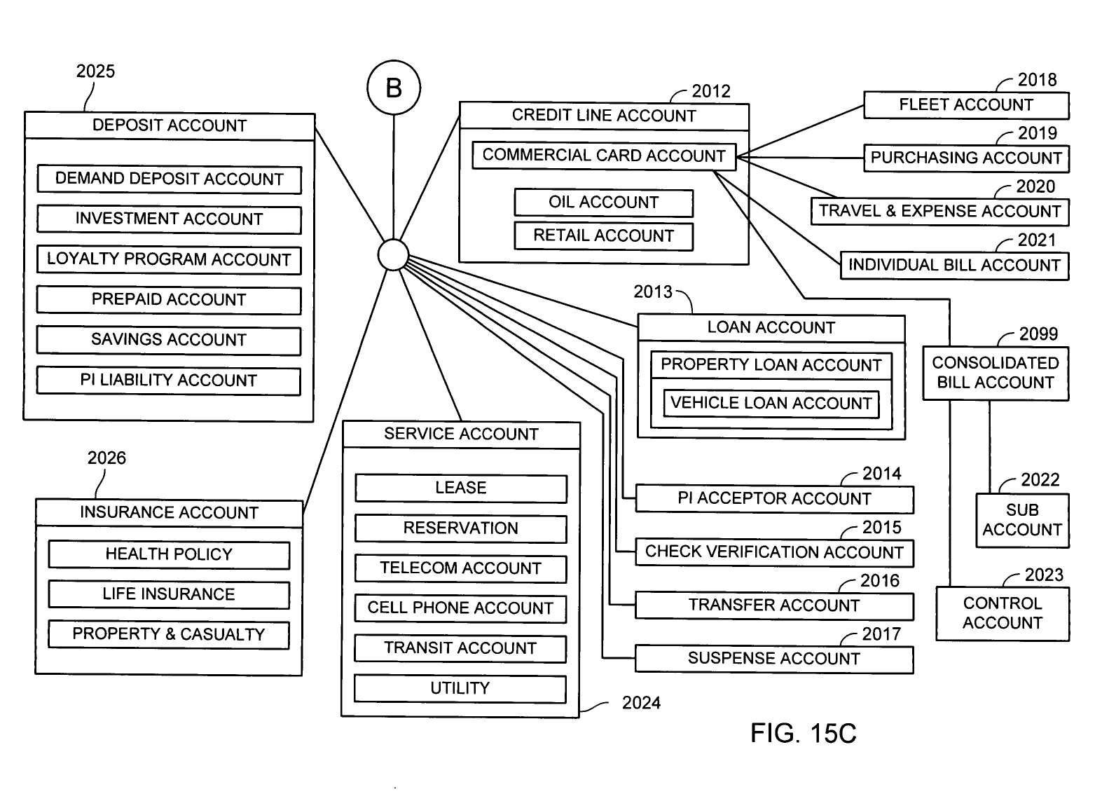

A more detailed view of the account subject area can be seen by reference to FIGS. 15A, 15B, and 15C which show an example of an account system 2000. In system 2000, an account database 2004 is used to store data for a plurality of different accounts managed by a service provider. An account can be understood to be a mechanism used to record, measure, and/or track financial and/or non-financial information related to a contractual agreement.

An entry can be established for each account managed by a service provider which is stored in the database 2004. For the service provider to keep track of each account that it deals with, an identifier can be generated to identify each particular account. In the case of an account managed by the service provider, an account internal identifier can be generated.

In addition to the “Account Internal Identifier” used to identify each account entry, additional information can be stored for each account managed by the service provider. For example, an “Account Client Identifier” can be stored as part of the entry. This attribute identifies which client of the service provider issued the account. For example, it could identify an account as a Bank One credit card account. Another data attribute that can be used as part of the account entry could be an “Account Client Controlled Identifier” which allows the client to assign their own identifier for the account which is unique within the context of that specific client's portfolio. Yet another data attribute that can be used as part of the entry is an “Account Authorization Prohibited Indicator”, so as to indicate whether authorization is prohibited for the account. Similarly, an “Account Bankruptcy Indicator” code can be used as part of the entry to indicate whether the account is associated with a bankruptcy proceeding. Another code that can be used is an “Account Charged Off Indicator.” This code can be used to indicate whether the account has been charged off.

An “Account Credit Balance Indicator” can be used as part of the data stored in an account database to indicate whether the account has a credit balance. Similarly, an “Account Delinquent Balance Indicator” can be used to indicate whether the party associated with the account is delinquent in some manner. Also, an “Account Frozen Indicator” can be associated as part of the entry to indicate whether the account has been frozen by the service provider, the client of the data processor, or a government authority. The “Account Open Indicator” can be used to indicate whether the account is open or closed. Furthermore, the “Account Original Open Date” can be used to indicate when the account was originally opened. The “Account Overlimit Balance Indicator” can be used to indicate whether the account balance is overlimit. This could be used for example in the case of a credit card account.

The “Account Revoked Indicator” can be used as part of the account entry to indicate whether the account has been revoked. Furthermore, the “Close Inactive Account Code” can be used to indicate whether an inactive account is closed or is to be closed. Other codes can be used as well to characterize the account. However, it is not necessary that all of the above attributes be used for any particular account. Rather, some attributes may lend themselves to use by special sub-types of accounts.

Block diagram 2000 shows examples of a variety of accounts that can be used under the system. For example, block 2012 indicates that data for a credit line account can be managed. A credit line account is a type of account based on an agreement for a financial institution to provide a customer with an open-ended line of credit that may be used repeatedly (e.g., revolves) up to a certain limit. Examples of credit line accounts are a commercial card account, an oil account, and a retail account. Another type of account is a loan account 2013. A loan account is a type of account that is established for a loan or a closed-end credit sale agreement in which the amounts advanced, plus any finance charges, are expected to be repaid in full over a definite period of time. Examples of a loan account are a property loan account and a vehicle loan account. Another type of account is a PI acceptor account as shown in block 2014. This is a type of account is based on an agreement to provide acquiring services for a Merchant. Other types of account include a check verification account 2015, a transfer account 2016, and a suspense account 2017. A transfer account is a type of account that is established to record a request for and the completion of a transfer of an item of monetary value between two points. A suspense account is an account created to manage transactions that need to be evaluated for fraud before allocating to an account balance.

Also shown in system 2000 are types of commercial card accounts, such as fleet account 2018, purchasing account 2019, travel and expense account 2020, individual bill account, 2021, consolidated bill account 2099, control account 2023, and sub account 2022.

Yet another type of account shown in system 2000 is service account 2024. A service account can be a type of account that is based on an agreement for a non-financial product. Examples shown for the service account are lease account, reservation account, telecom account, cell phone account, transit account, and utility account.

Still another type of account is the insurance account 2026. An insurance account is a type of account based on an agreement between parties whereby in return for payment of premiums, one party will compensate the other party for (generally unexpected) losses. Examples of insurance accounts are a health policy account, a life insurance account, and a property and casualty account.

The final example of a type of account shown in system 2000 is a deposit account 2025. A deposit account is a type of account based on an agreement for a product that is funded by customer deposits. Examples of deposit accounts are a demand deposit account, an investment account, a loyalty program account, a prepaid account, a savings account, and a PI liability account (e.g., a PI liability account could be an account set up by an organization to track its liability for one or more presentation instruments whose values are not tied to a particular customer account or an account party relationship).

In FIG. 15B, blocks 2004 and 2028, illustrate how an account to account relationship can be established. The account block 2004 reflects that data can be stored as an entry for each specific account. The account entries defined by block 2004 are considered internal accounts in that they are accounts managed by a service provider for clients or in the case of a company acting as a service provider itself, the accounts are the company's own accounts. A relationship between two internal accounts or an internal account and an external account can be established by pulling an account identifier for a first account, pulling an account identifier for a second account, and assigning those two identifiers an “Account to Account Relationship Type Code” as a new association in block 2028. The “Account To Account Relationship Type Code” identifies the type of relationship that exists between the two accounts. It is generally preferable to designate one of the accounts, such as the first account, as being the primary participant in the relationship and designating the remaining account as the secondary participant. Thus, for example, in the case of an account diversion, the system will understand which account to divert the transactions from and which account to post the transactions to.

An account to account relationship can be further defined by an “Account to Account Relationship Effective Date” and an “Account to Account Relationship End Date.” This allows the entry for the relationship to define when the relationship is in effect and when it is not in effect.

Examples of account to account relationships that can be identified by the account to account relationship type code are shown in block 2028 as account diversion, account transfer, and account reserve deposit account. These types of accounts can be further defined by additional attributes. For example, the account diversion relationship can be further described by an “Account Diversion Default Code.” Similarly, the account transfer relationship can be further described by an “Account Transfer Forward Posting Indicator.”

The account to account relationship entries can be operated on by a business rules database to execute the actions of each relationship. For example, at the appropriate time, the business rules can access the account diversion entries and identify the account to which the posting of individual transactions are posted. These business rules also indicate whether or not it is appropriate to post a given transaction to both accounts in the relationship.

Block 2030 illustrates how multiple accounts can be bundled together for purposes of account portfolio securitization. This allows formation of a group of accounts bundled or pooled together in the form of a bond. The “Account Internal Identifiers” are associated with an “Account Portfolio Securitization Identifier” so as to identify the bundle of accounts. Furthermore, an “Account Portfolio Securitization Pooling Description Text” can be used as an attribute for the entry that is created.

The account database can also be used to facilitate account groups as shown in the account group block 2034. An account group is a collection of accounts created so that they can be treated or processed as a group. System 2000 shows a financial institution, such as one of the service provider's clients as establishing the account group. An “Account Group Identifier” is generated by the service provider so that the service provider can identify the account group internally. Furthermore, additional attributes can be associated with each account group, such as an “Account Group Type Code” to identify a specific category of account groups. Another attribute that might be included is an “Account Group Description Text” attribute.

Examples of account groups shown in block 2034 are an account household group, an account management group, an account report group, an asset management account group, and a commercial card account group. An account household group can be, for example, an account group composed of some or all of the accounts belonging to individuals in a single household. An account management group can be a set of accounts that have selected properties maintained and/or general business processes invoked as a group. An account report group can be a type of account group created so that accounts can be attached and reported as a group. An asset management account group can be a type of account group created so that accounts of different account types belonging to one party can be reported as a group. A commercial card account group could be a grouping of accounts created to assist an organization in managing their spending.

Block 2040 illustrates one way in which accounts can be assigned to an account group. In block 2040, an “Account Internal Identifier” is retrieved from the account database represented by account block 2004 and associated with an “Account Group Identifier” from the account group database block 2034. In addition to the attributes, additional attributes can be assigned, such as a start date, an end date, an override indicator, and a role code.

Block 2048 illustrates how one can define accounts that qualify to be in one of the types of accounts shown in block 2034. Thus, qualification criteria represented by, for example, “Account Group Qualification Value Text”, “Account Group Qualification Percent Rate”, and “Account Group Qualification Maximum Number” can be used as qualification criteria to determine which accounts are to be added or removed from a particular account group. These criteria can be acted upon by business rules to determine the accounts that satisfy the criteria or that do not satisfy the criteria.

Block 2044 indicates that account groups themselves can be grouped as super groups of accounts. This is accomplished by building groups composed of established groups. Thus, for example, all the commercial card accounts in Omaha, Nebr. for Bank ABC can be grouped as one account group. Furthermore, all the commercial card accounts in Nebraska for Bank ABC can be grouped by grouping all the lower level groups, such as the previously established group of accounts in Omaha for Bank ABC. This grouping of other groups can be given an “Account Group Structure Level Name.”

Also shown in system 2000 is a collateral block 2008. The system can be configured to associate a piece of collateral with an account. Thus codes can be assigned to identify the collateral and link it with an “Account Internal Identifier” for an account.

Similarly, block 2027 shows a block indicating Fraud/Collections. This block allows the system to perform fraud monitoring and collection services. A particular account can be linked by “Account Internal Identifier” with a case queue that allows the case to be operated on by a fraud investigator or collection agent.

Communication Point Subject Area

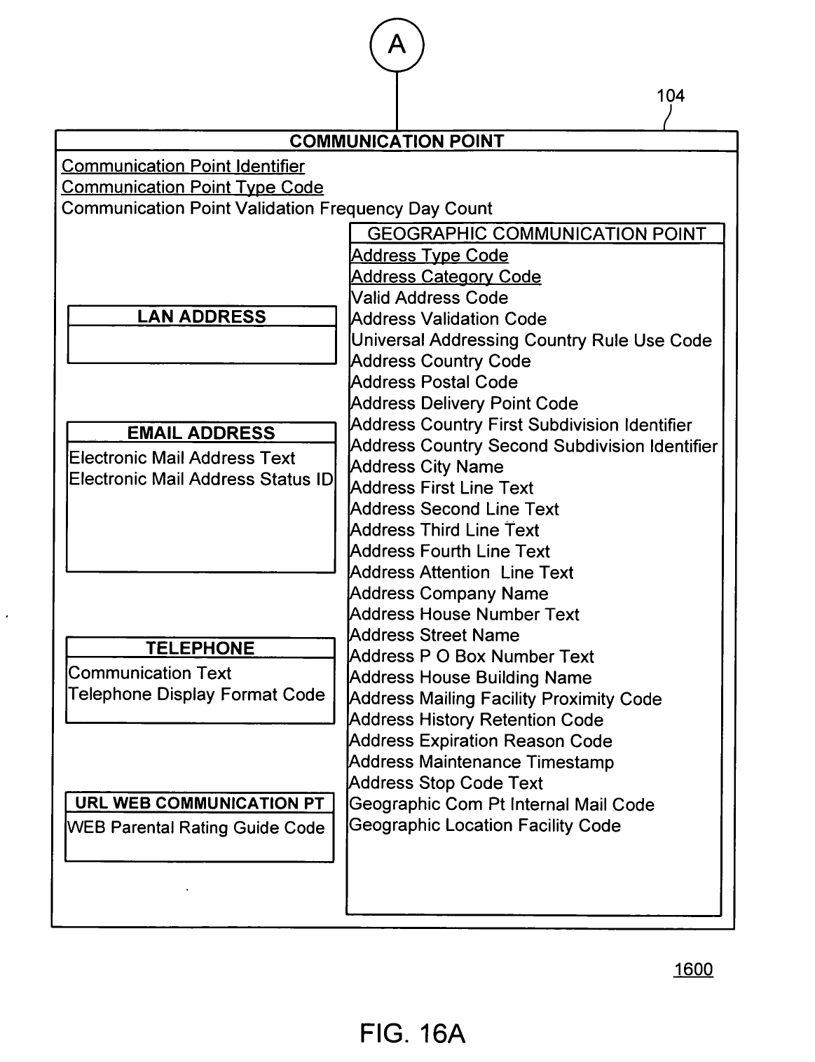

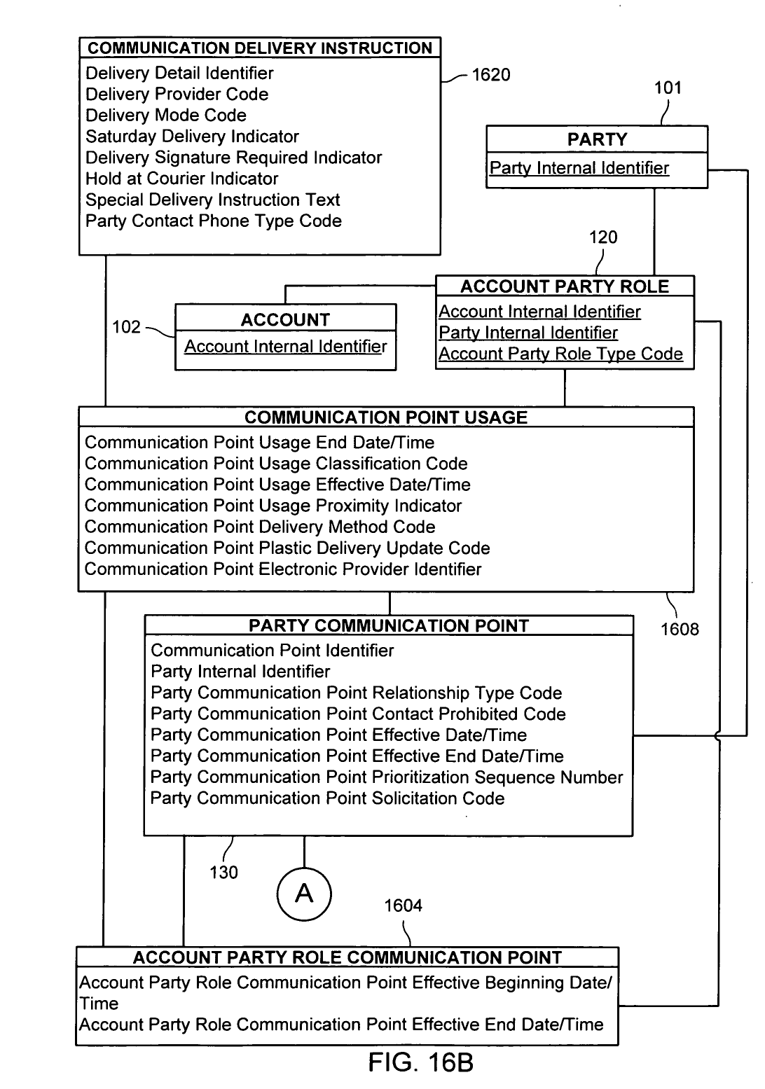

Referring to FIG. 16A, block 104 shows the Communication Point database components. A communication point is a way in which a party can be contacted. For example, a communication point can be a geographic address, a LAN address, an email address, a telephone number, a fax number, or a URL web communication point depending on the type code associated with it. The communication point data defines the communication point. An internal identifier generator can be utilized to generate internal ID's for each entry in the communication point database. It is then related to other subject areas such as party information using that internal ID. In this way, the communication point data can be kept separate from the party and the same communication point may be associated with many parties. Furthermore, it can be updated without affecting the other subject areas.

A geographic communication point can be specifically defined by a data entry which can include: an “Address Type Code”, an “Address Category Code”, a “Valid Address Code”, an “Address Validation Code”, a “Universal Addressing Country Rule Use Code”, an “Address Country Code”, an “Address Postal Code”, an “Address Delivery Point Code”, an “Address Country First Subdivision Identifier”, an “Address City Name”, an “Address First Line Text”, an “Address Second Line Text”, an “Address Third Line Text”, an “Address Fourth Line Text”, an “Address Attention Line Text”, an “Address Company Name”, an “Address House Number Text”, an “Address Street Name”, an “Address PO Box Number Text”, an “Address House Building Name”, an “Address Mailing Facility Proximity Code”, an “Address History Retention Code”, an “Address Expiration Reason Code”, an “Address Maintenance Timestamp”, an “Address Stop Code Text”, a “Geographic Communication Point Internal Mail Code”, and a “Geographic Location Facility Code.” Not all of these fields need to be defined in order to define a geographic communication point.

Similarly, a LAN address entry can be defined by appropriate data such as for IPv4 or IPv6. Furthermore, an email address can be defined with “Electronic Mail Address Text” and “Electronic Mail Address Status Indicator.” A telephone number can be defined with “Communication Text” and a “Telephone Display Format Code”, as yet another example.

A more detailed view of the interaction between the account, party, and communication subject areas can be seen by referring to FIGS. 16A and 16B. FIGS. 16A and 16B illustrate a system 1600 for implementing these interactions. In FIGS. 16A and 16B, the Party information database 101 is shown associated with data from the Account database 102 to establish the Account-Party Role relationship database 120. Similarly, the Party database 101 is shown associated with the Communication Point database 104 to establish the Party Communication Point relationship database 130.

The Party Communication Point relationship database 130 receives internal identifiers from both the Party database and the Communication Point database to establish an associative relationship between the entries associated with those internal identifiers. Thus, a communication point for a particular party is established. Associating Party and Communication Point in this manner allows a great deal flexibility and simplified communication point management. For example a single communication point can be related to many parties and a single party can inform the service provider of many different communication points, of varying types, that can be used to communicate with it. All communication points are typically created and regulated by some issuing body (Geographic—Local Governmental Agencies, Electronic—Internet Service Provider, Telephone—Telephone Service Provider, etc.) which periodically dictates maintenance changes (i.e. zip code changes, street name changes, area code changes, etc.). The implementation of mandated changes is easily accomplished due to the fact that each communication point occurs only once in the system. Additional information can also be added to this associative relationship. For example, FIGS. 16A and 16B illustrate that data for the Party Communication Point can include:

1) A “Party Communication Point Contact Prohibited Code” to indicate whether that communication point may be used to contact a party;

2) an “Party Communication Point Effective Date/Time” to indicate the date, time, or combination thereof upon which the communication point becomes active for that party and therefore can be used by the service provider to communicate with it;

3) an “Party Communication Point Effective End Date/Time” to indicate the date, time, or combination thereof upon which the communication point is no longer valid for that party and therefore cannot be used by the service provider to communicate with it;

4) a “Party Communication Point Prioritization Sequence Number” used to prioritize the possible means of communicating with a customer;

5) a “Party Communication Point Relationship Type Code” which is a code that represents the Party's view of their relationship to a specific communication point at a specific point in time, e.g., “HOME” for a home address, “EMPL” for an employer's address, “TMVA” for a temporary vacation address, and “BUSN” for a business;

6) a “Party Communication Point Solicitation Code” which can be used to determine privacy preferences for a party communication point.

These data fields allow a great deal of functionality to be accomplished with the architecture beyond that which can be accomplished with traditional systems. For example, with the “Party Communication Point Contact Prohibited” field, one can completely bar contact with the party at that communication point—for example, don't email me at my home email address.

Similarly, by providing effective dates for a communication point, a great deal of flexibility can be established in regard to where and when communications may be sent to a party during the year. For example, billing statements can be sent to a party at a vacation home communication point in Arizona during the winter months and sent to a home address in Nebraska during the remainder of the year. The “Party Communication Point Effective Date/Time” and “Party Communication Point Effective End Date/Time” would be used to determine when the billing statements, for example, can be sent to the Arizona address. A second entry in the Party Communication Point relationship database would be used to determine when the communication can be sent to the Nebraska address.

The “Party Communication Point Solicitation Code” can be used to indicate whether the party can be solicited at that communication point. With the enactment of new privacy legislation, it is beneficial for service providers to be able to track whether the party can be solicited at a particular communication point. This “solicitation code” field in the Party Communication Point relationship database can thus be used to determine whether the party has opted in for solicitation; or alternatively, it can be used to determine whether the party has opted out of being solicited under a different configuration. Under either configuration, the party's preferences can be tracked. For example, under an opt-in configuration, the field might initially be set to “no solicitation” as a default until the party affirmatively opts in and the field is changed to reflect that fact.

While the Party Communication Point Relationship database 130 associates a particular party with a particular communication point, instruction is still required as to what data or tasks are to be directed to that party at that communication point. This function can be accomplished by the interrelationship between the Communication Point Usage database 1608, account party role database 120, and the party communication point database 130. Certain concepts related to the communication point usage database has already been addressed above in the “COMMUNICATION POINT USAGE” section, and illustrated in Table C.

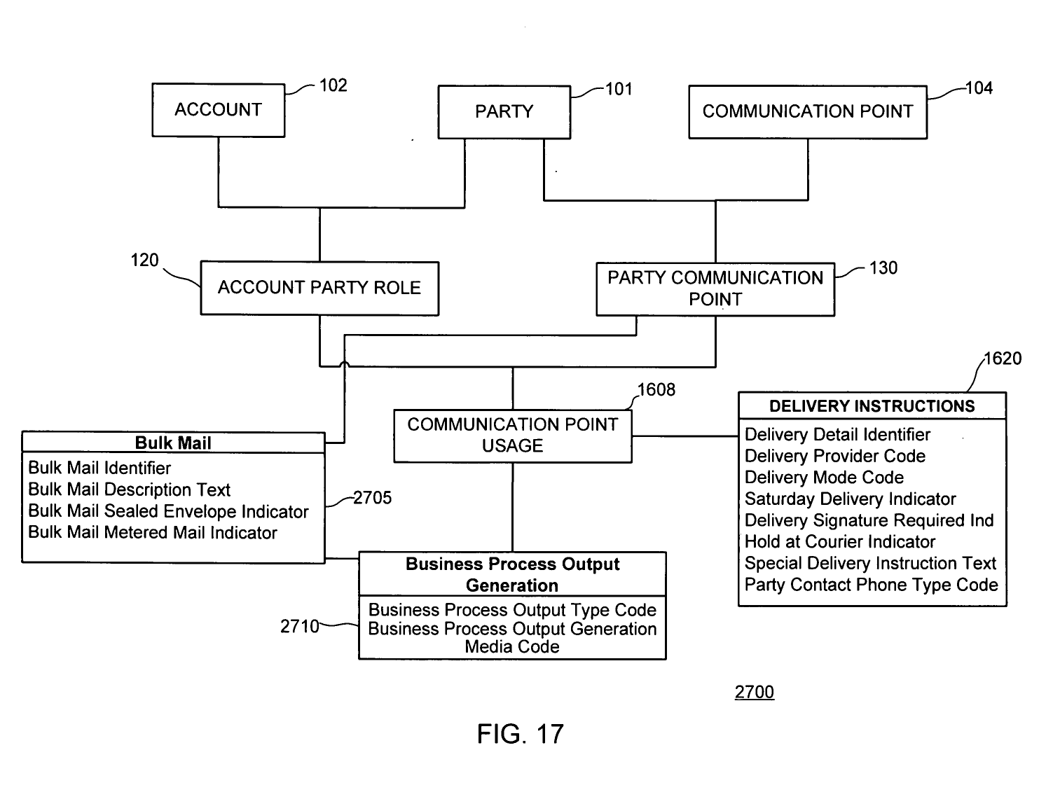

The Communication Point Usage database 1608 can be used to define the types of correspondence that are produced that can be sent to a communication point. For example, it can include a “Business Process Output Type Code” to represent the type of correspondence sent to a party. Examples of this type code include “BLL1” for billing correspondence, “PLST” for correspondence relating to plastics (e.g., plastic credit cards), “MALR” for plastic mailer, and “LTTR” for letters, “STMT” for statements. In one embodiment, this comprises a set of “Business Process Output Generation” entries, as shown with block 2710 in FIG. 17 (discussed in greater detail below).

Another field that may be accessible through the Communication Point Usage database 1608 (e.g., via the “Business Process Output Generation” entries, as shown with block 2710) is the “Business Process Output Generation Media Code.” This code may determine how output related to a business function will be generated. For example, the following codes could be used, where “Y” is the default code:

“Y”=electronic and paper will be produced;

“N”=paper will not be produced;

“L”=electronic and paper will be produced, paper should be turned off.

Another example of a field that may be accessible through Communication Point Usage database 1608 is a “Paper Stop Effective Date” field. This field stores the date that the customer indicated it was acceptable to stop generating correspondence in the form of paper. Thus, this helps to satisfy laws that require that paper statements be sent unless the customer indicates that such paper statements do not need to be sent—in lieu of on-line access or electronic mailings, for example.

The Communication Point Usage database 1608 itself helps to define delivery instructions for correspondence that could be communicated to a Party that has a role on an Account. For example, the following fields can be used: “Communication Point Usage End Date/Time”, “Communication Point Usage Classification Code”, “Communication Point Usage Effective Date/Time”, “Communication Point Usage Proximity Indicator”, “Communication Point Delivery Method Code”, “Communication Point Plastic Delivery Update Code”, and “Communication Point Electronic Provider Identifier.”

The “Communication Point Usage End Date/Time” may be a date, time, or combination thereof that a communication point is no longer effective for an account party role and business process. The communication point usage classification code is the period of time that the communication point may be used. This field is used in conjunction with the “Correspondence Type Code” to determine which address within a specific correspondence type code will be used to deliver correspondence. For example, the following values can be used: “P” for permanent, “R” for repeating, indicating that the address applies for a recurring and specific time period, “T” for temporary, indicating that the address is effective for a short time period, usually in the context of sending a replacement plastic to a vacation address.

The “Communication Point Usage Effective Date/Time” may be a date, time, or combination thereof that a communication point is effective for an account party role and business process. The “Communication Point Usage Proximity Indicator” is the value used to determine if the communication point and the mailing facility are in the same country when used for an account party role and business process. The “Communication Point Delivery Method Code” determines how the plastic will be mailed to the customer (e.g., first class mail, Airborne, FedEx, registered mail, or certified mail). The “Communication Point Plastic Delivery Update Code” is a code that determines the process available to the issuer for changing the mail code. Finally, the “Communication Point Electronic Provider Identifier” can be an identifier for an electronic correspondence provider (e.g., “5001”=“Billpay.com”).

The Bulk Mail block 2705 in FIG. 17 defines a single bulk that bundles together many specific instances of correspondence together with their associated party communication point information. A single Bulk may be comprised of several bundles of correspondence that share a common secondary destination. The bundled set of communique or “Bulk” is mailed to the party that receives the bulk for further distribution, such as when plastics for a group of people are first sent to an intermediary. The intermediary can perform a check of the individual envelopes in which the individual plastics are enclosed before depositing the individual envelopes in the mail, or perhaps engage in cross selling of other products to the individuals who come to pick up their correspondence. Another example of bulk mail delivery is where a group of envelopes are sent to an intermediary when the local postal service is unreliable (for example, in third world countries, or high crime areas within a country). The Bulk Mail block 2705 may include fields for a “Bulk Mail Identifier,” a “Bulk Mail Descriptive Text,” a “Bulk Mail Sealed Envelope Indicator,” and a “Bulk Mail Metered Mail Indicator.” A further discussion of Bulk Mail embodiments follows below in section “A. Bulk Mail.”

Communication Delivery Instructions 1620 helps define further delivery instructions that can be assigned to a specific business process output type of communication for a specific party playing a role on an account by providing fields for a “Delivery Detail Identifier”, a “Delivery Provider Code”, a “Delivery Mode Code”, a “Saturday Delivery Indicator”, a “Delivery Signature Required Indicator”, a “Hold At Courier Indicator”, a “Special Delivery Instruction Text”, and a “Party Contact Phone Type Code.” A further discussion of Communication Delivery Instructions 1620 follows below in section “B. Delivery Instructions.”

Also shown in FIGS. 16A and 16B is the Account Party Role Communication Point relationship database 1604. This relationship database establishes an associative relationship between entries in the Account Party Role database 120, the Communication Point Usage database 1608, and the Party Communication Point database 130. The association with Communication Point Usage database 1608 allows the service provider to establish the information needed to send a specific piece of communication to a specific party playing a role on an account at a communication point with which a relationship has been established to any party playing a role on that account. In addition to storing internal identifiers from the account party role database and the party communication point database, the account party role communication point database also stores the fields of “Account Party Role Communication Point Effective Beginning Date” and “Account Party Role Communication Point Effective End Date.” These fields allow the beginning and ending dates to be defined for communicating with a particular party playing a particular role on a particular account.

A. Bulk Mail: As noted above, FIG. 17 provides an exemplary embodiment illustrating a set of Bulk Mail 2705 entries, and their relation to the other components of the system 2700. Account 102, Party 101, and Communication Point 104 databases are each shown, and each of these databases may contain a number of separately stored entries. The Account Party Role 120 database and Party Communication Point 130 database are also shown, and may define Account-Party or Party-Communication Point relationships. In some embodiments, the Account Party Role 120 database may represent and define links between identifiers which reference independent entries from each stand alone (i.e., Account, Party, Communication Point) database. Similarly, the Party Communication Point 130 database may represent and define links between identifiers which reference independent entries from each stand alone database. These “secondary” relationships may allow the “primary” entries to retain their independence in their respective databases, and thus provide the flexibility outlined above. These concepts have been sufficiently detailed previously, and no further discussion is called for.

A Communication Point Usage database 1608 may be used to define relationships, between entries in an Account Party Role 120 database and a Party Communication Point 130 database. By way of example, a Communication Point Usage database 1608 itself may define a Communication Point for correspondence that may be communicated to a Party that has a role on an Account. Correspondence may be directed at a single party; alternatively, correspondence may be directed, in bulk, to an intermediate communication point which receives correspondence directed at one or more other parties of the plurality, as illustrated with block 2705. A Business Process Output Generation block 2710 may indicate the specific correspondence to be generated. Although the above provides general guidance on certain embodiments of the invention, the following explanation further illustrates the applicable concepts.

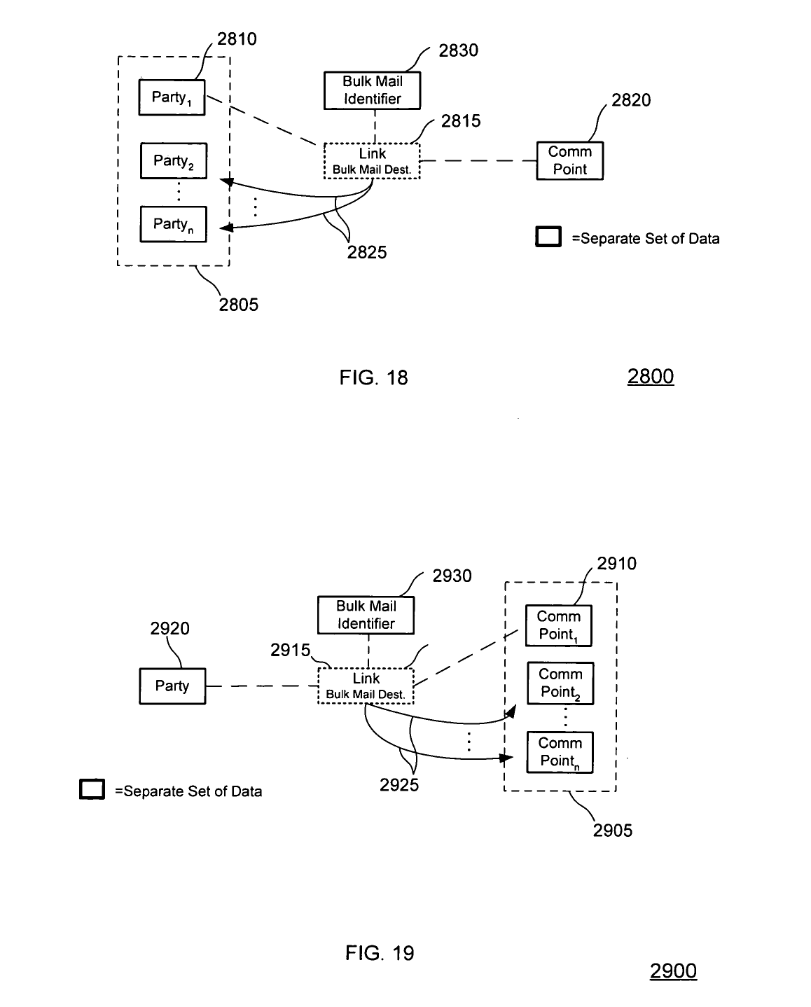

Alternative Bulk Mail Embodiments: FIG. 18 illustrates an exemplary bulk mail embodiment 2800, wherein data identifying a number of parties are each stored as a separate set of data. Each Party may be an entry in a Party database which is illustrated by the dashed area specified in reference numeral 2805. Data identifying a geographic Communication Point 2820 may also be stored separately from the data identifying the parties. A geographic Communication Point, as that term is used herein, may comprise a physical contact point where communications are received, such as a geographic address, a mailing address, a Post Office Box, a private mailbox, or any other location at which mail or other deliveries of physical items are received.

The set of data identifying the geographic Communication Point 2820 may be linked with a set of data identifying a first Party₁ 2810, to establish a party-communication point link 2815. The party-communication point link 2815 may be defined (e.g., with a bulk mail identifier 2830, or other bulk mail code) as a bulk mail destination comprising an intermediate point which receives correspondence directed at one or more other parties 2825 of the plurality. Such a link 2815 may be structured in a number of ways. For example, as noted above, the link may simply be an association between the identifier of the Party₁ 2810 and the identifier of the Communication Point 2820, thereby allowing the Party₁ 2810 and Communication Point 2820 to remain as separate sets of data. Such an identifier may a pointer in a database, a unique database key providing a link to the information, a hash, or any other means known in the art which provides a link or physical address identifying the desired information. An identifier may be configured to allow retrieval of data to which the identifier is assigned by referencing the identifier. There are a variety of additional methods known in the art for linking separate sets of data (e.g., Party Communication Point database), and any such methods may be used with various embodiments of the invention.

There are a number of types of correspondence that may be received in bulk, such as a bill, a statement, an account summary, an advertisement, a credit card, an other financial card, any other document or item, or any combination thereof. The correspondence of a bulk mailing may comprise a number of items. In some embodiments of the invention, a code may be used to indicate whether or not such items are to be sealed, or metered, before they are inserted into a bulk mailing. The system may provide addressing data for one or more of the items of correspondence (e.g., directly, or indirectly, from a Party 101, Communication Point 104, Account 102, Account Party Role 120, or Party Communication Point 130 database, or any combination thereof). The correspondence may be directed, after the bulk mailing, to the respective parties. Each Party may be associated with a different Communication Point (e.g., from the Communication Point 104 database) to provide for the delivery.

Embodiments of the invention may provide the data, or a subset thereof, to be included in the correspondence. The correspondence may also be specifically related to one, or more, different accounts, and each account may be stored as a separate set of data (e.g., in an Account 102 database). This relationship between an item of correspondence to be mailed in bulk and an account may be a link through an Account Party Role 120 database. Also, all of a certain correspondence type (e.g., account statement) for a specific party playing roles on several accounts could be mailed in a single envelope.

FIG. 19 illustrates an alternative exemplary bulk mail embodiment 2900, which further illustrates the flexibility inherent in various embodiments of the present invention. In this embodiment, data identifying a number of geographic Communication Points are stored as separate sets of data. Each geographic Communication Point may be an entry in a Communication Point database, illustrated by the dashed area specified in reference numeral 2905. A set of data identifying a Party 2920 may also be stored separately from the data identifying the plurality of geographic communication points (e.g., in a Party Database, or elsewhere). The set of Party data 2920 may be linked 2915 with data identifying a first geographic communication point 2910 of the plurality, to establish a party-communication point link in any manner discussed above (e.g., use of identifiers).

The party-communication point link 2915 may then be defined as a bulk mail destination comprising an intermediate point which receives correspondence directed 2925 at one or more other geographic communication points (i.e., members of the bulk mail grouping). Data comprising the link 2915 may be stored as an independent set of data. By way of example, a link may be so defined by associating a bulk mail identifier 2930 (or other bulk mail code) with the data comprising the link. Alternatively, the party-communication point link may be a replication (i.e., copy) of the party data 2920, a replication (i.e., copy) of the data identifying the first geographic communication point 2910, and data indicating that the party-communication point link is a bulk mail destination.

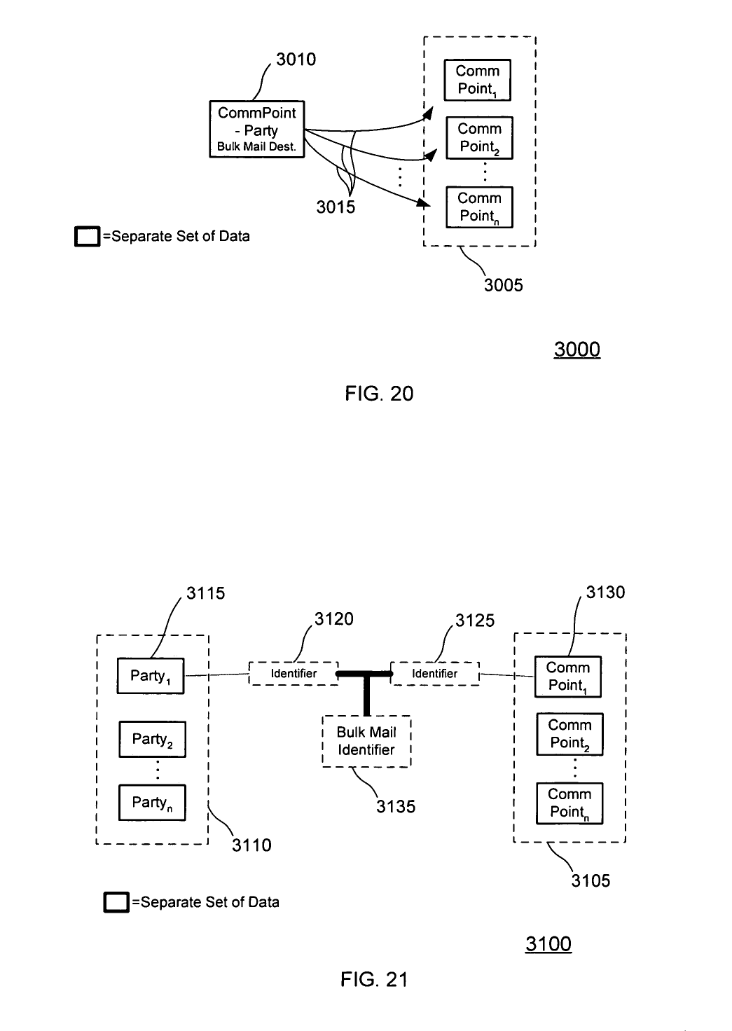

FIG. 20 illustrates yet another alternative exemplary bulk mail embodiment 3000, further illustrating the flexibility inherent in various embodiments of the present invention. In this embodiment, a party and a geographic communication point may be associated with each other at block 3010, and may then be defined as a bulk mail destination comprising an intermediate point which receives correspondence directed 3015 at one or more other geographic Communication Points. Data which comprises the party-communication point bulk mail association 3010 may be stored as an independent set of data. Therefore, in this embodiment, information defining a party, a communication point, and bulk mail relationship (e.g., a bulk mail identifier) may be stored together as a separate set of data in a separate database.

Data identifying a number of geographic Communication Points may be stored as separate sets of data. Each such geographic Communication Point may be an entry in a Communication Point database, illustrated by the dashed area specified in reference numeral 3005. Each of the geographic Communication Points to which correspondence is directed 3015 may be associated with a different Party (e.g., from a Party 101 database), and an account (e.g., from an Account 102 database), the associations structured in any manner described above.

FIG. 21 is a final block diagram illustrating an exemplary bulk mail embodiment 3100, further describing how identifiers may be used in various embodiments of the present invention. In this embodiment, data identifying a number of geographic Communication Points may be stored as separate sets of data. Each geographic Communication Point may be an entry in a Communication Point database, illustrated by the dashed area specified in reference numeral 3105. Sets of data each identifying a different Party may be stored separately. Each Party may be an entry in a Party database, illustrated by the dashed area specified in reference numeral 3110.

A first identifier 3120 may be stored, which provides a link to a set of data identifying a Party₁ 3115. A second identifier 3125 may be stored, which provides a link to a set of data identifying a Communication Point₁ 3130. The first identifier 3120, the second identifier 3125, and data 3135 defining the association between the Party₁ and the geographic Communication Point₁ as a bulk mail destination, may be linked. The data 3135 defining the association may simply be a bulk mail identifier. The associated data, 3120, 3125, and 3135, may be stored together as a separate set of data.

Each of the above Bulk Mail embodiments may be performed on a computer-readable medium having computer-executable instructions for performing the computer-implementable methods described. A computer system may be adapted to perform the computer-implementable methods described herein.

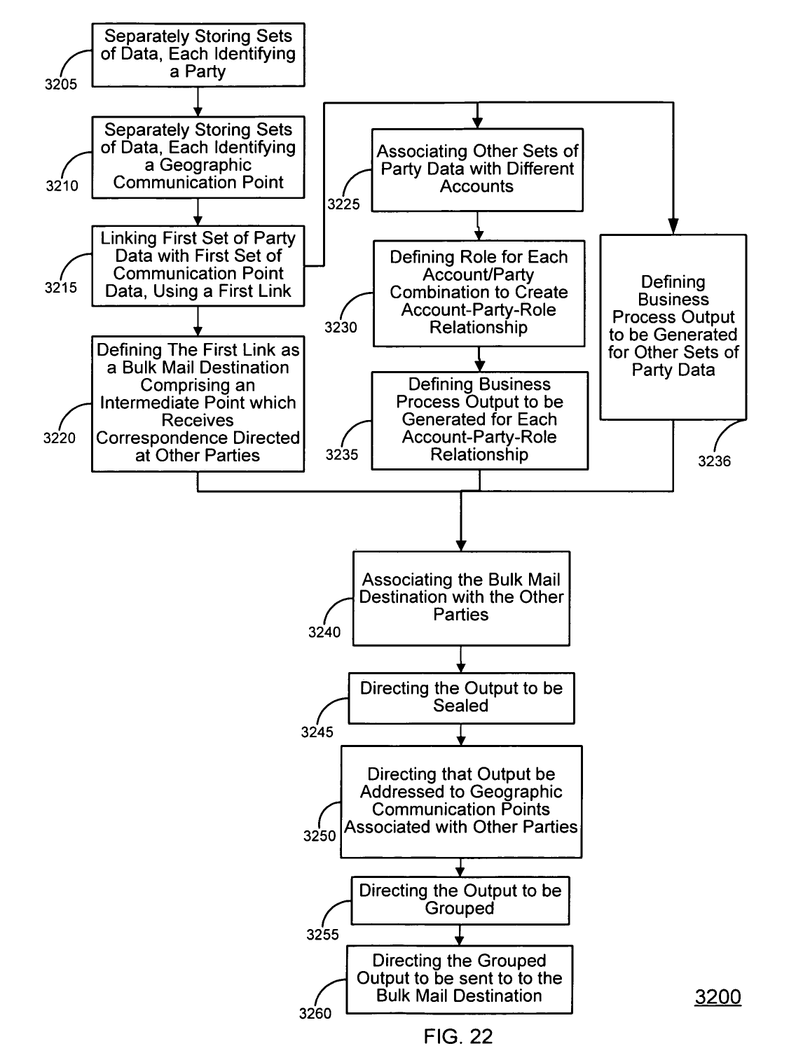

Exemplary Process Embodiments˜Bulk Mail: A further understanding of the invention may be gained with the following explanation of the methods associated with various exemplary embodiments. FIG. 22 sets forth an exemplary flow chart 3200 illustrating embodiments of the invention. At block 3205, separate sets of data may be stored, each identifying a party. At block 3210, additional sets of data may be stored separately, each identifying a geographic communication point. At block 3215, a first set of party data may be linked with a first set of communication point data, using a first link. The first link may be defined, at block 3220, as a bulk mail destination comprising an intermediate point which receives correspondence directed at other parties.

At block 3225, other sets of party data may be associated with one or more accounts, and each account may be different. At block 3230, a role for each account/party combination is defined to create an account-party-role relationship. A specific business process output generation may be defined for each account-party-role relationship at block 3235. A specific business process output generation may also be defined for still other sets of individual party data not associated with an account, at block 3236.

At block 3240, the bulk mail destination may be associated with the other parties. This may be accomplished by associating the output to be generated for the other parties with the bulk mail destination. At block 3245, there may be a direction that the output to be generated be sealed. This direction may be in the form of a code associated with the bulk mailing. At block 3250, there may be a direction that the output be addressed to geographic communication points associated with the other parties. At block 3255, there may be a direction that the output be grouped, and at block 3260, there may be a direction that the grouped output be sent to the bulk mail destination.

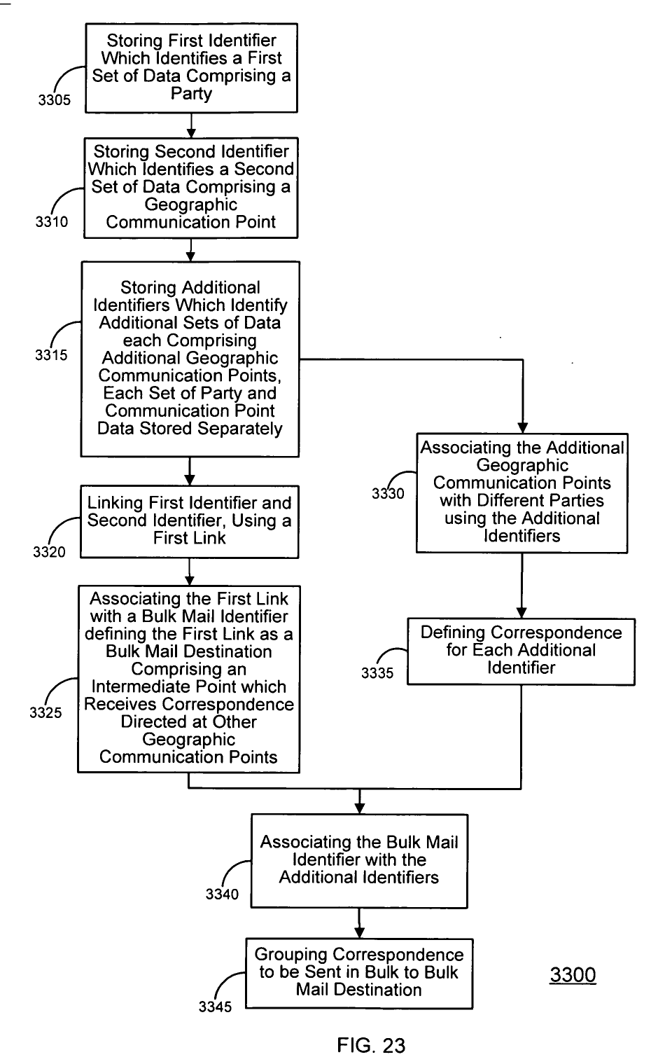

FIG. 23 sets forth another flow chart 3300 illustrating the use of identifiers in the invention. At block 3305, a first identifier may be stored which identifies a first set of data comprising a party. At block 3310, a second identifier may be stored which identifies a second set of data comprising a geographic communication point. At block 3315, additional identifiers may be stored which each identify additional sets of data which each comprise additional geographic communication points. Each set of party and communication point data may be stored separately.

At block 3320, the first identifier and second identifier may be linked, using a first link. The first link may, at block 3325, be associated with a bulk mail identifier defining the first link as a bulk mail destination comprising an intermediate point which receives correspondence directed at the additional geographic communication points. At block 3330, the additional identifiers may be associated with parties (e.g., through an Account Party Role database), creating additional links between the additional geographic communication points and related parties. At block 3335, correspondence for each additional identifier may be defined. The bulk mail identifier may be associated with the additional identifiers at block 3340. At block 3345, correspondence may be grouped to be sent in bulk to a bulk mail destination.

B. Delivery Instructions

As noted above, and illustrated in FIG. 16B, the Communication Point Usage database 1608 itself may define delivery instructions (e.g., effective dates, etc.) for correspondence that could be communicated to a Party that has a role on an Account. In addition, specific delivery instructions, at block 1620, may be associated with correspondence that is related to a relationship in a Communication Point Usage database 1608. These delivery instructions may be associated with a single mailing, with all mailings defined by a given relationship, or otherwise limited to specific relationships or correspondence in any manner known in the art.

By way of example, delivery instructions may be a selection of a delivery provider, a secondary delivery provider, a delivery provider code, a delivery service level, a Saturday delivery preference, a delivery signature preference; a special delivery instruction text, receipt instructions, confirmation instructions, time of delivery preferences, a code indicative of any of the foregoing delivery instructions, or any combination thereof.

Delivery instructions may also be instructions related to telephone contact and other forms of electronic communication (e.g., text messaging, email). Thus, instructions may indicate when and how electronic communications are to be delivered, and what content may be included. By way of example, there may be an indicator regarding whether receipts or acknowledgements should be sent with emails, preferences regarding cryptography and passwords, and the content of and instances in which emails should be sent. “Delivery instructions,” as that term is used herein, may include any code, text, or other indicator which indicates the manner in which communications may be delivered for a given relationship in a specified timeframe.

FIG. 17 shows an embodiment 2700 illustrating an exemplary set of Delivery Instructions at block 1620, and their relation to the other components of the system 2700. Account 102, Party 101, and Communication Point 104 databases are each shown, and each of these databases may contain a number of separately stored entries. The Account Party Role 120 database and Party Communication Point 130 database are also shown, and may define Account-Party or Party-Communication Point relationships as described above. These associations may allow the “primary” entries to retain their independence in their respective databases, and thus provide the flexibility outlined above.

The Communication Point Usage database 1608 may be used to define relationships, between entries in an Account Party Role 120 database and a Party Communication Point 130 database. By way of example, a Communication Point Usage database 1608 itself may define a Communication Point for correspondence that may be communicated to a Party that has a role on an Account. Also, a Communication Point Usage database 1608 itself may define a Communication Point for correspondence that may be communicated to a Party that is not associated with an Account. The Delivery Instructions 1620 may then be associated with the defined relationship, to indicate the manner in which correspondence directed at a Communication Point for a Party that has a role on an Account, or a Party that doesn't play a role, may be delivered. The delivery instructions may be associated with a particular article of correspondence, or any grouping of correspondence for a given relationship.

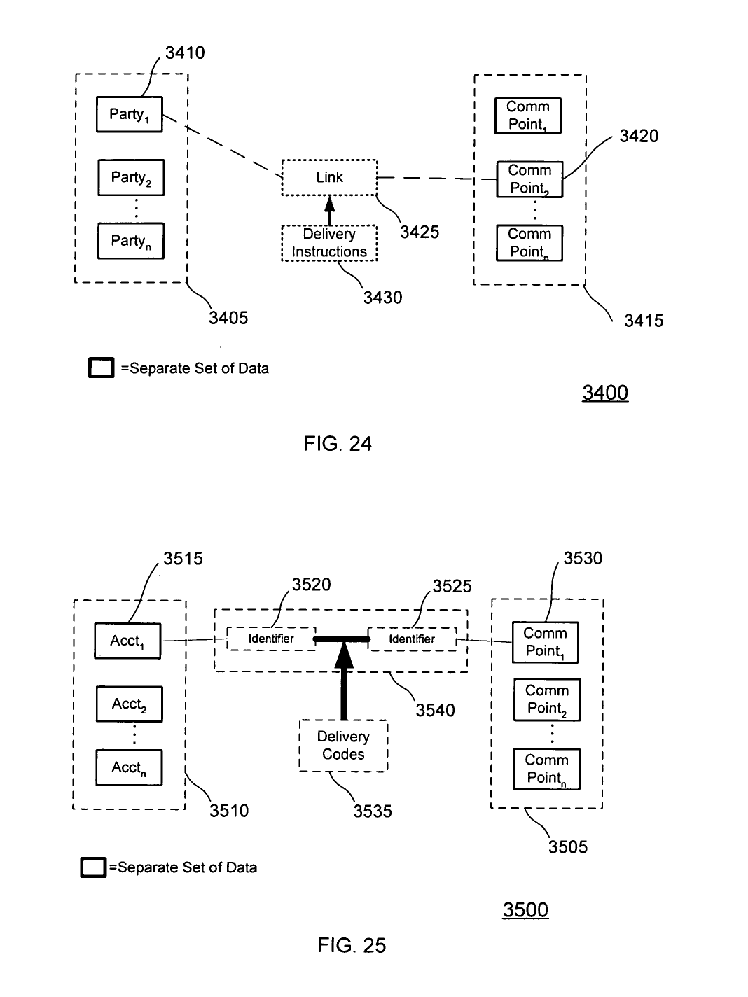

Alternative Delivery Instruction Embodiments: In addition to associations described above, there are further embodiments of the invention providing for the storage of data to define delivery instructions. FIG. 24 illustrates a block diagram setting forth an exemplary embodiment 3400 of the invention. The area 3405 denoted by the dashed line may represent a Party Database, wherein Party₁ through Partyₙ are each stored as independent sets of data. The area 3415 denoted by the dashed line may represent a Communication Point Database, wherein Communication Point₁ through Communication Point n are each stored as independent sets of data.

A Party₁ 3410, and a Communication Point₂ 3420, may then be linked at block 3425. This link may be structured in a number of ways. For example, the link may simply be an association between a Party₁ 3410 identifier and a Communication Point₂ 3420 identifier, thereby allowing the Party₁ 3410 and Communication Point₂ 3420 to remain as separate sets of data. An identifier may be an address in database, a unique database key or hash providing a link or lookup of the information, any other means known in the art which provides a link or address identifying the desired information. An identifier may be configured to allow retrieval of data to which the identifier is assigned by referencing the identifier. There are a variety of additional methods known in the art for linking separate sets of data, and any such methods may be used. At block 3430, a set of delivery instructions (or codes or identifiers thereof) defining the manner in which correspondence associated with the link should be delivered. In some embodiments, there may be any number of similar links between various Party Database entries and Communication Point Database entries. The same Party and Communication point may, however, have more than one link, such links defining delivery instructions for different accounts (and, in some cases, roles). A link may be stored in a Party-Communication Point Database, or elsewhere.

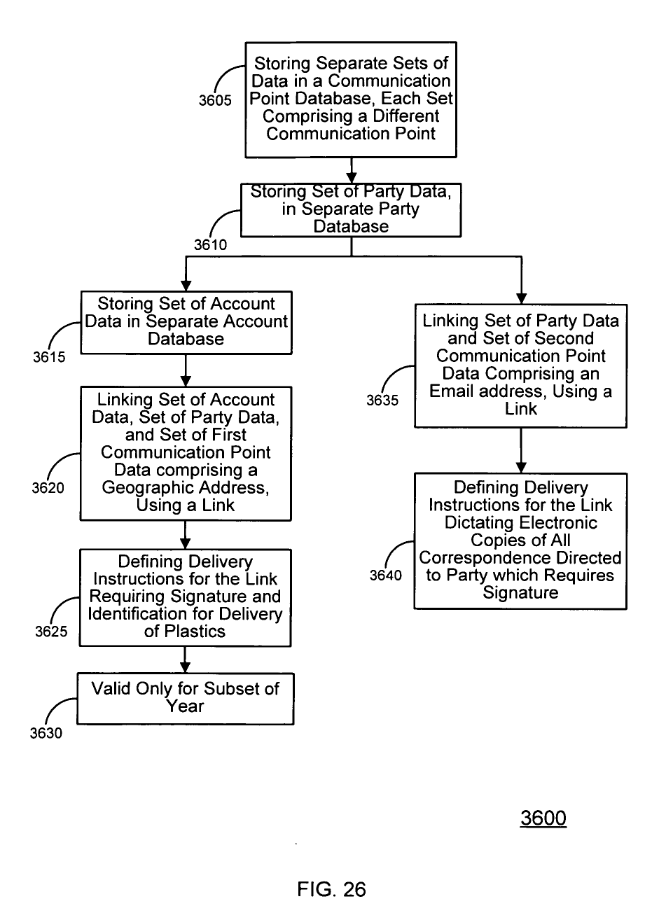

FIG. 25 is a block diagram illustrating an exemplary delivery instruction embodiment 3500, further describing how identifiers may be used in various embodiments of the present invention. In this embodiment, data identifying a number of geographic Communication Points may be stored as separate sets of data. Each geographic Communication Point may be an entry in a Communication Point database, illustrated by the dashed area specified in reference numeral 3505. Sets of data each identifying a different Account may be stored separately. Each Account may be an entry in an Account database, illustrated by the dashed area specified in reference numeral 3510. The Account database and Communication Point database may be stored separately.

A first identifier 3520 may be stored, which provides a link to a set of data identifying an Account₁ 3515. A second identifier 3525 may be stored, which provides a link to a set of data identifying a Communication Point₁ 3530. The first identifier 3520 and the second identifier 3525 may be linked as indicated by the dashed area specified by reference numeral 3540 (in alternative embodiments, however, an Account entry and Communication Point entry may be linked in any manner as known in the art).

Codes (e.g., alphanumeric identifiers) 3535 defining delivery instructions may be associated with the linked data 3540 (e.g., linked with the Account₁ identifier 3520 and the geographic Communication Point₁ identifier 3525). The data 3535 defining the association may, in some embodiments, also be made up of delivery instructions in text or another format. The associated data, 3520, 3525, and 3535, may be stored together as an independent set of data.

Each of the above Delivery Instruction embodiments may be performed on a computer-readable medium having computer-executable instructions for performing the computer-implementable methods described. A computer system may be adapted to perform the computer-implementable methods described herein.

Exemplary Process Embodiments˜Delivery Instructions: A further understanding of the invention may be gained with the following explanation of the methods associated with various exemplary embodiments. FIG. 26 sets forth an exemplary flow chart 3600 illustrating various embodiments of the invention. At block 3605, separate sets of data may be stored in a Communication Point database, with each set comprising a different communication point. At block 3610, a set of party data may be stored in a separate Party database. Each party within the Party database may be stored as a separate set of data.

At block 3615, a set of account data may be stored in a separate Account database, and each account within the Account database may be stored as a separate set of data. At block 3620, the set of account data, the set of party data, and a set of first communication point data comprising a geographic address may be linked. At block 3625, delivery instructions for the link may be defined, the instructions requiring signature and identification for delivery of plastics for the party. The delivery instructions may be defined, at block 3630, as valid for only an annually recurring subset of a year. In other embodiments, different ways may be used to indicate the effective dates or times for the instructions (e.g., see discussion of Relationship Scheduling, above, for an explanation of different time periods).

In another example of how the Party database and Communication Point database may be used, at block 3635 the set of party data may be linked with set of second communication point data from the Communication Point database comprising an email address. At block 3640, delivery instructions may be defined for the link, requiring email delivery of electronic copies of all correspondence directed to the party when the correspondence requires signature for receipt.

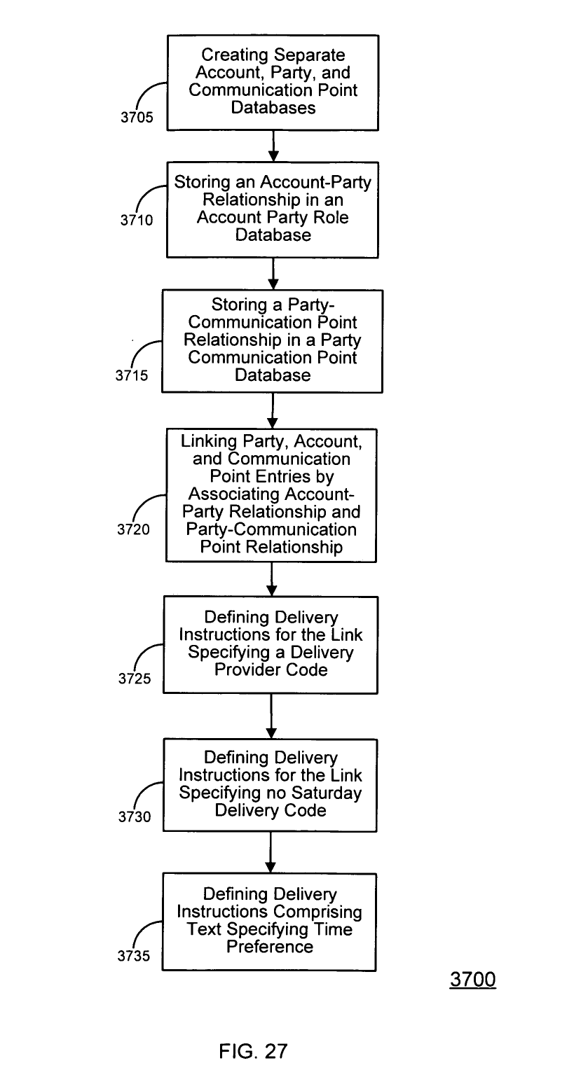

FIG. 27 sets forth another exemplary flow chart 3700 illustrating various embodiments of the invention. At block 3705, separate Account, Party, and Communication Point databases may be created. At block 3710, an account-party relationship may be stored in an Account-Party role database, comprising a link between an entry in the Account database and an entry in the Party Database. At block 3715, a party-communication point relationship may be stored in an Party-Communication Point database, comprising a link between an entry in the Communication Point database and the entry in the Party Database. At block 3720, party, account, and communication point entries may be linked by associating the account-party relationship and the party-communication point relationship.

At block 3725, delivery instructions for the link may be defined, specifying a code associated with a selected delivery provider (e.g., U.S. Postal Service). At block 3730, delivery instructions may be defined for the link, specifying a code indicating no Saturday delivery. Additional delivery instructions may be defined for the link at block 3735, comprising text indicating time preferences.

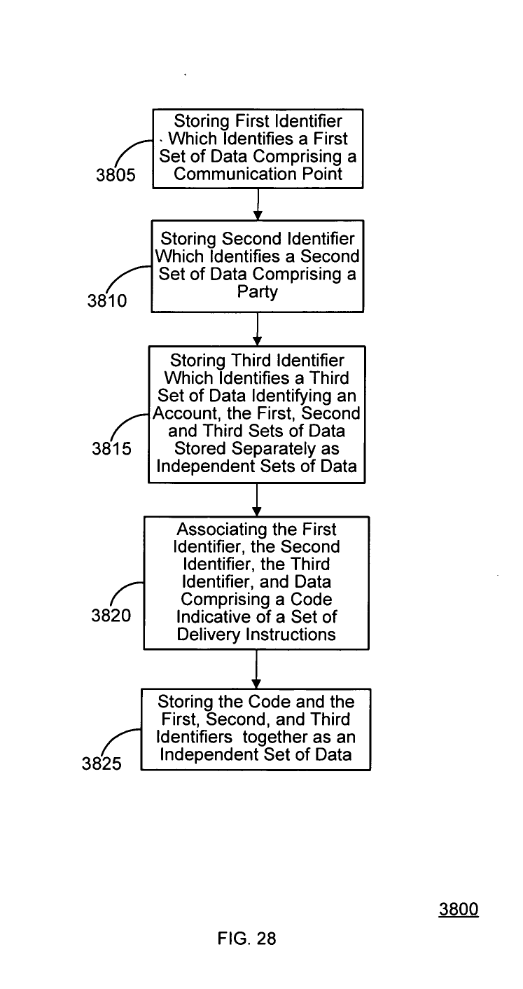

FIG. 28 sets forth another flow chart 3800 illustrating the use of identifiers in the invention. At block 3805, a first identifier may be stored which identifies a first set of data comprising a communication point. The first set of data may be located in a Communication Point database, in which each communication point is stored separately. At block 3810, a second identifier may be stored which identifies a second set of data comprising a party. The second set of data may be located in a Party database, where each set of party data is stored separately. At block 3815, a third identifier may be stored which identifies a third set of data comprising an account. The third set of data may be located in a Account database, in which each account is stored separately.

At block 3820, the first identifier, the second identifier, the third identifier, and one or more codes indicating delivery instructions, may be associated, using a link. The link may consist of the first identifier, the second identifier, the third identifier, and the one or more codes, which may be stored as an independent set of data at block 3825.

Conclusion: It should be understood that use of the term “associate” in this specification is intended to mean that two or more data elements are grouped as an associative set of data. For example, two internal identifiers grouped as a unique data entry form an associative set. Furthermore, the two data entries that those two internal identifiers reference are also consequently formed as an associative set of data. The term “link” may be used in similar fashion.

Similarly, it should be understood that the use of the term “relate” in this specification is intended to mean that two or more entities are established in a relationship with one another. Thus, when a particular party is related to a particular account, for example, a relationship is established between the particular party and the particular account. This is often implemented by associating the internal identifier for the particular party with the internal identifier for the particular account as a data set so as to identify the entities as being related to one another.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It should be noted that the methods and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Also, it is noted that the embodiments may be described as a process which is depicted as a flow chart, a data flow diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before, or after, the above elements are considered. Accordingly, the above description should not be taken as limiting the scope of the invention, which is defined in the following claims.

What is claimed is:

1. A method of storing data for communicating with a party according to certain instructions, the method comprising:
storing data identifying a plurality of communication points each comprising a physical or virtual contact point where communications are received, each communication point of the plurality stored as a separate set of data;
storing a set of data identifying a party, separately from the data identifying the plurality of communication points;
linking the set of party data with a set of data identifying a first communication point of the plurality, using a link; and
associating delivery instructions with the link, the delivery instructions specifying a procedure to use in delivering communications directed to the party at the first communication point.

2. The method of claim 1, wherein the first communications point comprises a selection from the group consisting of a geographic address, an email address, an electronic address, a telephone number, and a fax number.

3. The method of claim 1, wherein the delivery instructions comprise a selection from the group consisting of a delivery provider, a secondary delivery provider, a delivery provider code, a delivery service level, a Saturday delivery preference, a delivery signature preference; a special delivery instruction text, receipt instructions, confirmation instructions, time of delivery preferences, a code indicative of any of the foregoing delivery instructions, and any combination thereof.

4. The method of claim 1, further comprising:
associating a set of data identifying an account with the link.

5. The method of claim 4, wherein the set of account data is associated with the link via an account party role relationship.

6. The method of claim 4, wherein the set of account data is stored separately from the set of party data and the set of first communication point data.

7. The method of claim 1, further comprising:
storing a set of data identifying a second communication point separately from the set of party data and the set of first communication point data;
linking the set of party data with the set of second communication point data, using a second link; and
associating different delivery instructions with the second link, specifying a different procedure to use in delivering communications to the second communication point for the party.

8. The method of claim 7, wherein each link is stored separately from the set of party data, the set of first communication point data, and the set of second communication point data.

9. The method of claim 1, further comprising:
associating the delivery instructions with the link for a specified period of time.

10. The method of claim 1, further comprising:
assigning a first identifier to the set of first communication point data; and
assigning a second identifier to the set of party data;
wherein the link comprises the first identifier and the second identifier.

11. A computer-readable medium having computer-executable instructions for performing the computer-implementable method for storing data of claim 1.

12. A method of storing data for communicating with a party according to certain delivery instructions, the method comprising:
storing data identifying a plurality of communication points each comprising a physical or virtual contact point where communications are received, each communication point of the plurality stored separately;
storing a set of data identifying an account separately from the data identifying the plurality of communication points;
linking the set of account data with a set of data identifying a first communication point of the plurality, using a link; and
associating delivery instructions with the link, the delivery instructions specifying the procedure to use in delivering communications to the first communication point for the account.

13. The method of claim 12, wherein, the link comprises an association between an account party role relationship and a party communication point relationship.

14. The method of claim 12, further comprising:
associating a set of data identifying a party with the link.

15. The method of claim 12, further comprising:
assigning a first identifier to the set of data identifying the first communication point; and
assigning a second identifier to the set of account data;
wherein the link comprises an association between the first identifier and the second identifier.

16. The method of claim 15, further comprising:
storing the first identifier, the second identifier, and the delivery instructions as a first set of data stored separately from the set of account data and the data identifying the plurality of communication points,
wherein the link comprises the first set of data.

17. A computer system adapted to perform the computer-implementable method for storing data of claim 12.

18. A method of storing identifiers to allow communication with a party according to certain instructions, the method comprising:
storing a first identifier which identifies a first set of data comprising a communication point, wherein the communication point defines a physical or virtual contact point where communications are received;
storing a second identifier which identifies a second set of data comprising a party, the second set of data stored separately from the first set of data; and
associating the first identifier, the second identifier, and data comprising delivery instructions specifying the procedure to use in delivering communications directed to the party at the first communication point, to thereby create a different set of data stored separately from the first set of data and the second set of data.

19. The method of claim 18, wherein the different set of data comprises the first identifier, the second identifier, and the data comprising delivery instructions.

20. The method of claim 19, further comprising:
associating a limited effective time period with the different set of data.

21. The method of claim 18, further comprising:
storing a third identifier associated with a third set of data identifying an account, the third set of data stored separately from the first set of data and the second set of data, wherein the different set of data further comprises the third identifier.

22. The method of claim 18, further comprising:
storing a third identifier associated with a third set of data identifying a different communication point, the third set of data stored separately from the first set of data and the second set of data; and
associating the third identifier, the second identifier, and data comprising different delivery instructions specifying the procedure to use in delivering communications to the different communication point for the party.

23. A computer-readable medium having computer-executable instructions for performing the computer-implementable method for storing data of claim 18.

24. A system of storing data for communicating with a party according to certain instructions, the system comprising:
a communication point database for storing data identifying a plurality of communication points each comprising a physical or virtual contact point where communications are received, each communication point stored separately;
a party database for storing a set of data identifying a party, the party database stored separately from the communication point database; and
a communication point usage database comprising a link between the set of party data and a first communication point of the plurality of communication points, wherein the link further comprises delivery instructions specifying the procedure to use in delivering communications to the first communication point for the party.

25. The system of claim 24, the system further comprising:
an account database for storing data identifying a plurality of accounts, the account database stored separately from the party database and the communication point database, wherein the first link is further associated with an account of the plurality of accounts.

26. The system of claim 24, wherein,
the first communication point data is assigned a first identifier;
the set of party data is assigned a second identifier; and
the first link comprises an association between the first identifier and the second identifier.

27. The system of claim 26, wherein,
the first link comprises the first identifier and the second identifier;
the first link is stored separately from the account database, the party database and the communication point database.
